(19) United States
(12) Patent Application Publication
(10) Pub. No.: US 2026/0153096 A1
(43) Pub. Date: Jun. 4, 2026

(54) Rotary Propeller Featuring Enhanced Slot Effect Through Staggered Blade Configurations

(71) Applicants: Jeffrey Brian Downard, Flagstaff, AZ (US); Abigail Rebecca Downard, Flagstaff, AZ (US); Jacob Dorian Downard, Flagstaff, AZ (US)

(72) Inventors: Jeffrey Brian Downard, Flagstaff, AZ (US); Abigail Rebecca Downard, Flagstaff, AZ (US); Jacob Dorian Downard, Flagstaff, AZ (US)

(21) Appl. No.: 19/255,975

(22) Filed: Jun. 30, 2025

Related U.S. Application Data
(60) Provisional application No. 63/667,314, filed on Jul. 3, 2024.

(51) Int. Cl. F04D 29/18; B63H 1/16; B63H 1/28; B64C 11/00; B64C 11/32; B64C 11/48

(52) U.S. Cl. CPC F04D 29/185; B63H 1/16; B63H 1/28; B64C 11/325; B64C 11/48; B64C 11/001

(57) ABSTRACT

The present invention provides a propeller assembly having staggered pairs of blades arranged to enhance hydrodynamic and aerodynamic efficiency across marine, aerial, energy, and industrial applications. Each propeller incorporates pairs of forward and aft blades configured with controlled rake, skew, and pitch to generate a coherent slot effect, particularly in the outer third of the blade span where linear velocity and thrust are greatest. By aligning the forward blade with the aft blade, the invention reduces turbulence, cavitation, and drag while improving thrust, flow coherence, and noise attenuation. The aft blade may be pitched differently than the forward blade to accelerate fluid and sustain slot efficiency. The disclosed configuration integrates conventional design parameters—foil profile, chord length, and blade area—into paired geometries, enabling performance advantages over single-blade systems. Applications include marine propellers, aircraft propulsion, turbines, and fluid-moving devices such as pumps and fans.

### CROSS REFERENCE TO RELATED APPLICATIONS

This application claims the benefit of priority to U.S. provisional applications No. 63/667,314 filed on Jul. 3, 2024 and No. 63/827,179 filed on Jun. 20, 20225; the entirety of all applications listed above are hereby incorporated by reference herein.

### FIELD OF THE INVENTION

The present invention relates to rotary propellers designed for improved hydrodynamic and aerodynamic performance across a variety of applications. These applications include, but are not limited to, marine propulsion systems for vessels such as boats, personal watercraft, and submarines; aerial propulsion systems for vehicles including airplanes, helicopters, and unmanned aerial vehicles (drones); and fluid movement systems in industrial contexts, such as fans, blowers, and pumps.

Further, the invention pertains to rotary devices used in energy generation, such as wind turbines and water turbines, where maximizing thrust or fluid displacement efficiency is critical. The propeller designs disclosed herein aim to provide performance advantages over conventional blade arrangements by leveraging a staggered, multi-blade configuration that enhances the slot effect, reduces cavitation and turbulence, and improves overall flow dynamics.

This invention may also be applied to any system requiring efficient transfer of momentum to or from a fluid medium, particularly where the manipulation of boundary layer interactions and flow coherence between blades can yield measurable improvements in thrust, drag reduction, energy efficiency, or noise attenuation.

### SUMMARY

The present invention provides a novel propeller design optimized for rotary propulsion in hydrodynamic and aerodynamic contexts. The design leverages a refined slot effect achieved between staggered sets of blades, particularly emphasizing configurations where the blades extend significantly beyond the radius of the central hub. In such propellers, evenly spaced blades at the hub radiate outward, resulting in a greater separation between blade tips than at their bases. This invention is particularly advantageous for marine and aerial applications, where a substantial proportion of thrust is generated in the outer third of each blade. This is due, in part, to the fact that the outer regions of the blades travel through the medium at higher linear velocities than the inner or middle regions, thus contributing disproportionately to propulsion.

Although prior designs have implemented staggered blades—both in older marine propellers and in modern gas turbine compressors—these configurations do not provide the specific alignment or blade shaping necessary to produce a slot effect between paired blades at their outer extents. In turbine compressors, for instance, blades are often much shorter than the hub diameter, allowing the fluid medium to flow efficiently between blade rows without requiring complex geometric adjustments. In contrast, the present invention addresses the challenge of achieving a coherent, high-efficiency slot effect in propellers where the blades are nearly as long or longer than the hub diameter, particularly focusing on optimizing fluid interaction in the outer third of the blade span.

This is accomplished by a novel arrangement of blade rake and skew within each staggered pair. The forward and aft blades of a given pair are positioned to maintain a precise spatial relationship across their span, with particular attention to aligning the trailing edge of the forward blade with the leading edge of the aft blade in the outer third region. In a paradigmatic configuration, this alignment is achieved by sculpting the skew and rake profiles of each blade such that the separation distance between the blades remains optimal throughout their length. Moreover, the pitch of the aft blade may be slightly greater than that of the forward blade to improve fluid acceleration and maintain slot coherence. For example, in a marine outboard propeller application, the forward blade might have a pitch of 17 inches while the aft blade has a pitch of 19 inches, producing a complementary aerodynamic interaction.

Designing such a propeller requires addressing a more complex set of variables than conventional single-blade designs. The invention teaches how to integrate standard propeller design parameters—such as foil cross-section, cupping, chord length, and blade area—across a coordinated blade pair to maintain and enhance the slot effect, especially in the high-efficiency outer third of the propeller. This represents a significant advance in the art of rotary propulsion, offering engineers and designers a framework to optimize multi-blade, staggered propeller systems for greater thrust, efficiency, and flow coherence.

### BACKGROUND OF THE INVENTION

The conceptual foundation for this invention arises from over seventy years of research into the aerodynamic phenomenon known as the “slot effect,” which has played a critical role in sailboat design. Notably advanced by researchers such as Arvel Gentry, this body of work has explored how wind flowing through the slot between a forward jib and an aft mainsail can significantly enhance lift generation and reduce drag. The slot effect operates by accelerating airflow through the narrow channel formed between the two sails, energizing the boundary layer on the leeward side of the mainsail and delaying flow separation. This coordinated aerodynamic interaction leads to a net increase in thrust and efficiency, particularly when the sails are optimally trimmed and the vessel is on a close reach.

This provisional patent application, which draws on priority established in prior provisional applications, develops and refines variations of a novel innovation that translates these aerodynamic principles into rotary propeller design. By embedding a slot-like interaction between staggered blades in a rotating system, the invention provides a means to achieve enhanced propulsion efficiency in both hydrodynamic and aerodynamic environments. The innovation is applicable across a broad range of contexts, including marine propulsion (e.g., boats, personal watercraft, submarines), aerial propulsion (e.g., airplanes, helicopters, drones), and flow management systems such as pumps, fans, and turbines.

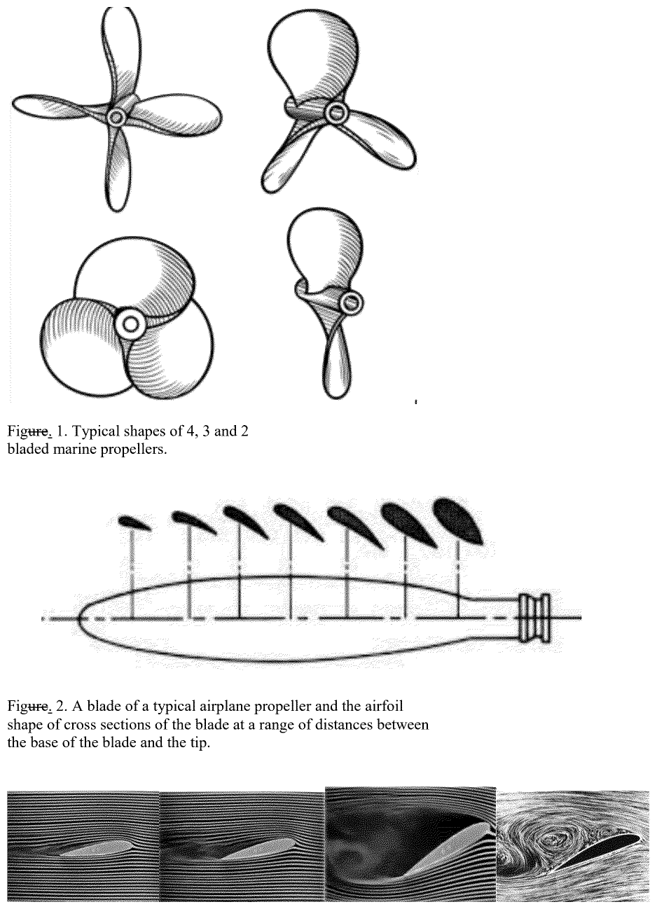

Traditional propellers used in marine and aerial propulsion typically employ a uniform blade layout in which all blades are radially aligned and rotationally symmetric. The leading edges of all blades are equidistant from the forward end of the central hub, and the trailing edges are aligned at an equal distance from the aft end of the hub. This configuration, while straightforward to manufacture and analyze, does not take advantage of coordinated aerodynamic or hydrodynamic interactions between blades. FIG. 1 illustrates a representative example of such a conventional marine propeller, while FIG. 2 shows cross-sectional airfoil profiles of a standard recreational aircraft propeller blade.

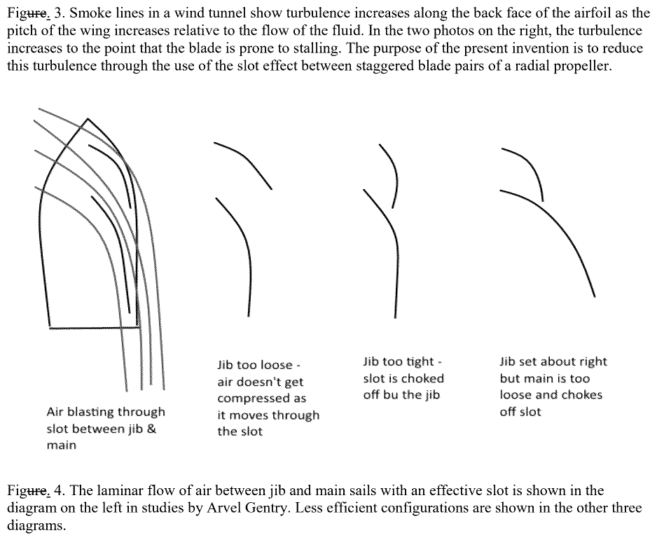

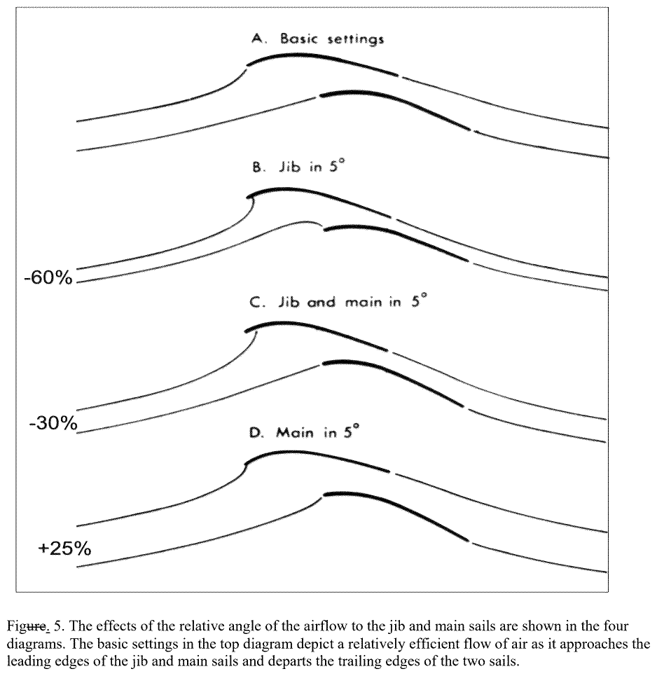

Despite advances in blade shaping, material design, and pitch control, conventional propellers remain limited by their failure to exploit flow interactions between blades. FIG. 3 illustrates the tendency of turbulence to increase as the pitch of an airfoil increases relative to the flow of a fluid medium. Unlike sails on a rigged sailboat, conventional blades operate in relative isolation, with each blade designed to generate lift or thrust independently. The present invention breaks from this paradigm by treating paired blades as interactive elements within a dynamic fluid system, with coordinated shaping, staggering, and spacing optimized to promote a slot effect analogous to that found in high-performance sail rigs and are considerably optimized in the case of aero-rig designs which maintain a consistent slot at all points of sail. In the case of the present invention, considerable experience operating an acro-rigged sailboat while witnessing the performance gains as compared to typically rigged sailboats served as a significant source of inspiration.

While staggered blade arrangements have been employed in other contexts—most notably in gas turbines and ducted fan systems—the underlying principles and geometric constraints in those systems differ significantly from the present invention. In gas turbines, for instance, the compression and turbine stages typically consists of alternating rows of rotating and stationary blades, each arranged axially along a central shaft. These blades are typically short relative to the diameter of the hub and operate under high-pressure, high-temperature conditions in a tightly ducted environment. The close confinement of the working fluid, combined with the short blade span, allows for a relatively predictable and efficient flow through each stage without the need for special shaping to maintain coherent interaction between individual blades.

Recent designs having complementary rows of blades do achieve some degree of slot effect between pairs of blades, but these designs do not teach how to achieve an effective slot effect when the blades are nearly as long as or longer than the diameter of the hub. The main reason is that they do not address the special challenges involved in maintaining aligned at the out third of longer pairs of blades, which requires the optimization of combination of complex variables, including rake, skew, foil profile, blade shape, chord length, etc. for the fore and aft blades of each pair.

Similarly, ducted fans and axial compressors often employ multiple blade rows arranged in a staggered fashion to manage flow gradients and reduce turbulence. However, these configurations rely heavily on the controlled environment of a duct or casing, and the blades are again comparatively short, with little need for extensive coordination across the full radial span. In such designs, the interaction between blade rows is optimized primarily through axial spacing and overall stage architecture, rather than through precise aerodynamic alignment of staggered blades along their full chord and span.

These systems do not teach how to create an efficient slot effect between long, paired blades that extend significantly beyond the radius of the central hub, especially in open-flow environments such as marine propellers or aircraft rotors. The staggered rows in turbines or fans are functionally distinct from the interactive, slot-generating blade pairs described in the present invention.

Moreover, existing propeller designs that include multiple blade planes or slightly offset blade positions do not provide sufficient guidance for aligning the trailing edge of a forward blade with the leading edge of a staggered aft blade to preserve flow coherence. These arrangements typically emphasize structural or mechanical considerations rather than optimizing for aerodynamic slot performance. As a result, they fail to exploit the efficiency gains that can be achieved when two staggered blades are shaped and positioned to work in tandem, as described in the present invention.

Arvel Gentry, a preeminent authority in naval architecture and fluid dynamics, conducted pioneering work on the aerodynamic interaction between sails, particularly the phenomenon now widely known as the slot effect. Through a series of influential articles and detailed analyses, Gentry advanced a new understanding of how airflow is accelerated and managed between a forward jib and an aft mainsail on a sailboat. His work marked a departure from conventional wisdom by emphasizing the complex interplay of circulation, pressure gradients, and boundary layer control that occurs in the narrow region between properly trimmed sails.

Gentry's research focused on the conditions under which a well-configured slot between sails could dramatically enhance propulsion efficiency. When a sailboat is positioned at an advantageous angle to the wind—such as on a close reach—the airflow entering the slot between the jib and mainsail is accelerated, resulting in reduced pressure on the leeward side of the mainsail and improved lift generation. This configuration supports smoother, more laminar flow along both sails while mitigating flow separation and turbulence that would otherwise result in drag. Gentry demonstrated through experimental wind tunnel data and theoretical modeling that the slot's shape, alignment, and relative angles are crucial to realizing these aerodynamic gains.

Figures from Gentry's publications (e.g., reproduced in FIG. 4 of this application) illustrate various slot configurations and their relative efficiencies. In the optimal configuration, the trailing edge of the jib is positioned and shaped to guide airflow seamlessly onto the windward side of the mainsail. Less efficient configurations, shown in comparative diagrams, demonstrate the negative effects of improper spacing or angular misalignment, which can lead to stagnation, flow separation, and diminished propulsion efficiency.

The present invention draws on these insights and adapts them in a novel way to the design of rotary propellers. Whereas Gentry's analysis concerns linear airflow between flexible, planar sails, this invention introduces the concept of a rotary slot formed between staggered, rigid blades arranged in a circular configuration. By extrapolating the slot effect from a sailing context to a rotary one, the invention presents an innovative framework for designing blade pairs that emulate the beneficial aerodynamic interaction of a jib and mainsail-now realized through carefully coordinated rake, skew, pitch, blade shape, foil section, and radial placement.

This adaptation represents a fundamental departure from conventional rotary blade design, which typically treats each blade as an isolated unit optimized for individual performance. In contrast, the present invention treats each pair of blades as an integrated aerodynamic system, where the aft blade operates in close aerodynamic cooperation with the forward blade to produce a cumulative slot effect. By shaping and orienting the forward and aft blades to maintain appropriate spacing and alignment—particularly in the outer third of the blade span, where thrust generation is greatest—the invention achieves a fluid acceleration pattern akin to that observed in Gentry's slot-effect sail configurations.

FIG. 5 illustrates the effect of varying relative wind angles on the airflow dynamics around a jib and mainsail configuration. The top diagram in the figure depicts a relatively efficient aerodynamic setup in which the apparent wind approaches the leading edges of the jib and mainsail at favorable angles and departs cleanly from the trailing edges. This setup facilitates a smooth, accelerated flow through the slot, maximizing lift and minimizing drag. The remaining diagrams depict less efficient alignments, where poor trimming or suboptimal wind angles degrade the slot effect, resulting in flow separation, increased drag, or reduced forward thrust.

To understand how a jib-mainsail combination enhances aerodynamic performance, particularly in terms of boundary layer behavior and flow stability, it is useful to compare the Reynolds number behavior of a mainsail operating alone with that of a mainsail assisted by a properly trimmed jib. The Reynolds number (Re), defined as the ratio of inertial to viscous forces in a fluid, is critical in determining whether flow remains laminar or transitions to turbulence along a surface. For a mainsail operating alone, the chord length from mast to leech defines the characteristic length for calculating Re. At the scale of typical sailing rigs, the high Reynolds number usually results in early transition to turbulent flow, increasing drag and reducing aerodynamic efficiency.

However, when a jib is added in a configuration that generates an effective slot effect, several beneficial aerodynamic changes occur. First, the velocity of air between the jib and mainsail increases due to a Venturi-like acceleration through the slot. This elevated velocity reduces the stagnation pressure and creates a more favorable pressure gradient over the leeward surface of the mainsail. Second, the energized flow emerging from the slot adheres more effectively to the mainsail's surface, delaying boundary layer separation and maintaining laminar flow across a greater portion of the sail. Third, although the geometric chord of the mainsail remains constant, the effective aerodynamic behavior-especially in terms of sustaining laminar flow-improves as if the flow were experiencing a lower effective Reynolds number, due to a more favorable distribution of dynamic pressure.

These aerodynamic insights from the field of sailing directly inform the principles underlying the present invention. By translating the slot effect into a rotary configuration using paired, staggered blades, the invention leverages the same fundamental mechanisms: acceleration of the working fluid between a forward and aft blade, pressure gradient optimization, and flow reattachment or delay of separation. These adaptations are especially significant in the outer third of the blade span, where both Reynolds number and thrust contribution are greatest. The careful engineering of relative blade rake, skew, pitch, and spacing ensures that the rotary slot effect can replicate, in a dynamic rotating medium, the benefits historically associated with fixed sail arrangements on high-performance sailing vessels.

This foundational understanding of the slot effect provides the conceptual basis for reimagining how fluid flow can be managed in rotary propulsion systems. In particular, the present invention adapts the underlying aerodynamic principles of the slot effect—originally observed in sailboats with jibs and mainsails—to rotary devices, by implementing staggered blade pairs configured to manage flow in an analogous manner.

Whereas the slot effect in sailing vessels is created by two separate, but coordinated, surfaces (jib and mainsail) that interact with a predominantly linear airflow, the rotary analog involves two blades—one forward and one aft—arranged in a staggered pair on a rotating hub. This staggered configuration must account not only for the axial flow direction (as with wind over a boat) but also for the complex helical path of fluid around rotating blades. Thus, the design challenge in rotary systems is not merely spatial positioning, but temporal and angular coordination of the flow induced by rotation.

### Boundary Layer Management in Rotating Blade Pairs

In conventional propeller and fan designs, each blade operates in relative isolation. While designers carefully manage blade pitch, chord, foil shape, and cupping to delay boundary layer separation and maintain efficient flow, these design strategies are generally applied individually to each blade. The present invention instead introduces a cooperative aerodynamic relationship between two adjacent blades—one leading (forward) and one trailing (aft)—configured to create a “rotary slot” between them. The goal is to sustain laminar flow on the trailing blade longer than would be possible without assistance from the leading blade, especially in the high-velocity region near the blade tips.

This laminar maintenance is achieved through a combination of:
Rake and skew adjustments that position the aft blade in a trajectory optimized to receive accelerated flow from the forward blade.
Axial staggering, such that the forward blade's trailing edge is just forward of the aft blade's leading edge along a helical arc, preserving a consistent slot-like channel between them.
Pitch differentials, where the aft blade has a slightly greater pitch than the forward blade, compensating for the altered pressure profile and optimizing the thrust contribution in the outer third of the blades.

### Comparative Analysis: Turbines and Ducted Fans

In axial compressors and turbines, staggered rows of stator and rotor blades are used to progressively compress or expand a working fluid. These staggered blade rows are generally short in length compared to the diameter of the hub and are often embedded within ducted or shrouded systems that control flow and mitigate tip losses. In these systems, efficient fluid guidance is achieved by aligning blade rows so that flow exits one set of blades (e.g., stators) at an angle ideal for entering the next (e.g., rotors), but this is only feasible due to the high degree of confinement and the relatively short blade lengths.

In contrast, marine and aerial propellers typically operate in open, unshrouded environments, with longer blades extending well beyond the diameter of the central hub. The result is that a significant portion of thrust and lift is generated in the outer third of the blades-precisely the region where flow is fastest, and where tip vortices, flow separation, and cavitation are most challenging. The present invention addresses this region directly by coordinating blade shape and placement in a way that achieves a beneficial flow interaction akin to that between sail surfaces in a slot rig.

Unlike ducted fans or multi-stage turbines, where external structures help regulate flow, the rotary slot effect introduced in this invention operates autonomously within each blade pair. No shrouding is required. Instead, careful geometric design and spacing—especially in rake, skew, and pitch angle—ensures that the inner, middle and especially the outer third of the trailing blade receives flow that is already partially accelerated, oriented, and stabilized by the leading blade.

### Mechanical Configurations Enabling the Rotary Slot Effect

The implementation of the rotary slot effect described in the present invention requires precise control over the spatial and geometric relationship between two staggered blades arranged as a forward and aft pair. Unlike conventional propellers in which all blades share the same axial alignment, the invention departs from this approach by configuring blades in pairs that are offset along the axis of rotation. Each blade pair consists of a forward blade mounted closer to the leading edge of the central hub and an aft blade mounted further aft. These staggered blade pairs are arranged so that each pair shares a radial plane, yet is separated longitudinally, allowing for intentional aerodynamic or hydrodynamic interaction between the trailing edge of the forward blade and the leading edge of the aft blade.

A key feature of this configuration is the axial stagger between the forward and aft blades of a given pair. The longitudinal displacement is calibrated to achieve a coordinated flow interaction that enhances propulsion efficiency by creating a rotary analogue of the slot effect observed in sail aerodynamics. If the blades are positioned too closely along the axis, the desired flow channel between the blades collapses, reducing efficiency and increasing turbulence. Conversely, if the axial distance is too great, the interaction between blades becomes weak or ineffective. The precise axial offset required depends on several factors, including the expected rotational speed of the propeller, the diameter of the blades, and the operating characteristics of the medium—air or water—through which the propeller moves.

To further refine the interaction between blades, the invention incorporates varying degrees of rake and skew across each blade in a pair. Rake, the fore-aft inclination of the blade relative to the central hub axis, is used to adjust the axial positioning of the blade tip. Skew, defined as the angular rotation of the blade's centerline relative to the radial orientation of the hub, modifies the orientation of the blade along the plane of rotation. In preferred configurations, the amount of rake and skew is not uniform across the length of the blade but varies along its radius. In a paradigmatic example, the inner third of the blades is only slightly raked and skewed, ensuring structural integrity near the hub. The middle third begins to show greater divergence between forward and aft blades, while the outer third exhibits the most pronounced shaping. The purpose of this shaping is to align the trailing edge of the forward blade as closely as possible with the leading edge of the aft blade, creating an effective slot that enhances laminar flow through the outer third of the blade pair.

Another essential aspect of the mechanical configuration is the difference in pitch between the forward and aft blades. In a preferred embodiment, the forward blade is pitched to a slightly lower helical angle than the aft blade. This arrangement ensures that the forward blade accelerates the surrounding fluid and delivers a preparatory thrust, while the aft blade capitalizes on the energized flow by applying a slightly greater pitch and producing additional thrust. In a representative example of a marine propeller for a recreational boat, the forward blade may have a pitch corresponding to 17 inches of travel per revolution, while the aft blade in the pair has a pitch of 19 inches. This staggered pitch configuration contributes to improved performance under acceleration, enhanced fuel efficiency, and reduced cavitation.

The airfoil or hydrofoil cross-sectional shape of each blade in the pair is also independently optimized but coordinated as part of a unified aerodynamic system. The forward blade is typically shaped to generate lift while minimizing flow disruption, with emphasis on accelerating the fluid across its surface and establishing a low-pressure region at its trailing edge. The aft blade, by contrast, is designed with a leading-edge profile that captures and redirects the forward blade's wake. This enables the aft blade to sustain laminar flow for a greater portion of its chord length and to extract additional thrust from the already-accelerated fluid. Foil parameters such as chord length, camber, thickness distribution, and cupping are determined based on the specific application and are calculated jointly for each blade pair rather than independently.

The hub itself is modified to support the staggered blade pairs and their varying mechanical demands. In some configurations, the hub is equipped with longitudinal splines or helical channels that allow each blade to be mounted at a different axial and radial position. Blade mounting may be accomplished through bolted flanges, keyed inserts, or integrated castings depending on the size and stress tolerances required by the application. Special attention must be paid to dynamic balance, as the asymmetry introduced by staggered blade pairs can result in vibration or harmonic distortion if not counteracted by mass balancing and proper alignment.

### Arvel Gentry's Studies on the Slot Effect and its Application to Propeller Design

Arvel Gentry's groundbreaking work on the aerodynamic properties of sailboats, specifically his studies on the slot effect between jibs and mainsails, revealed insights that challenge traditional thinking about air flow between the sails. Previous assumptions suggested that the jib functions primarily by “funneling” air to the mainsail, increasing its speed. However, Gentry's research debunked this hypothesis, demonstrating that the slot between the jib and mainsail plays a more nuanced and critical role. Rather than funneling air, the slot serves to smooth and accelerate the airflow between the sails, creating a more uniform pressure gradient. This uniformity prevents flow separation, which is a common cause of turbulence and drag.

Gentry's work also showed that the interaction between the two sails modifies the effective Reynolds number. By altering the airflow dynamics, the presence of the jib lowers the Reynolds number required to maintain laminar flow over a greater portion of the mainsail's surface. In the absence of the jib, the mainsail alone tends to experience early flow separation, characterized by a higher Reynolds number due to the sail's larger characteristic length. This results in earlier transition to turbulence, which reduces the overall aerodynamic efficiency. However, when a jib is used in conjunction with the mainsail, the optimized slot effect helps to delay the transition to turbulence by maintaining smoother, more controlled airflow over the mainsail. The effect of the jib, therefore, is not just to accelerate the flow but also to create a more favorable pressure distribution, leading to greater aerodynamic efficiency.

Drawing parallels to the field of propeller design, the principles identified by Gentry can be applied to the rotary propulsion systems. When a propeller is designed with staggered pairs of blades, the forward blade in each pair conditions the water flow before it reaches the aft blade, much like how the jib conditions the air before it reaches the mainsail. The gap between the forward and aft blades acts like the slot between the sails, allowing the fluid to accelerate as it passes through, reducing the potential for flow separation at the trailing edge of the aft blade. The aft blade benefits from this pre-conditioned flow, which leads to smoother fluid movement over its surface, reducing drag and minimizing turbulence. This process improves the overall efficiency of the propeller, enabling it to generate more thrust with less power input.

### Comparison to a Standard Three-Bladed Propeller

To further illustrate the advantages of staggered blade pairs, a comparison can be made between a standard three-bladed propeller and one designed with staggered blade pairs. A typical three-blade propeller, as shown in FIG. 1, has blades that are arranged symmetrically around the hub. In this configuration, each blade encounters undisturbed flow as it rotates through the medium, leading to higher turbulence and drag, especially on the trailing blades.

In contrast, a staggered-pair three-blade propeller has forward and aft blades that are offset, allowing the flow conditions to be pre-conditioned by the forward blade before reaching the aft blade. This configuration minimizes the potential for flow separation and reduces turbulence in the wake of the forward blade. As a result, the aft blade experiences smoother, more energized flow, which decreases drag and improves the overall efficiency of the propeller. This effect is particularly beneficial at higher rotational speeds, where the outer blades are moving at much faster velocities relative to the fluid.

The following table outlines a comparison between the features of a standard three-blade propeller and a staggered-pair three-blade propeller:

| | Standard 3- | Staggered-Pair 3- |
|---|---|---|
| Feature | Blade Propeller | Blade Propeller |
| Flow Over | Each blade encounters | Aft blades encounter |
| Blades | undisturbed flow | pre-conditioned flow |
| Turbulence & | Higher potential for | Reduced separation due to |
| Drag | flow separation | pre-conditioned water flow |
| Efficiency | Lower due to more | Higher due to smoother |
| | abrupt flow | transitions and reduced drag |
| | transitions | |
| Reynolds Number | More abrupt turbulence | Delayed turbulence, |
| Effects | transition | potentially maintaining |
| | | laminar flow longer |
| Pressure | More pressure variations | More gradual pressure |
| Gradient | per blade pass | changes, improving |
| | | thrust efficiency |

### Potential Advantages of the Staggered-Pair Design for Aerial and Marine Propellers

The staggered-pair design for both aerial and marine propellers offers several potential advantages over traditional configurations. One of the primary benefits of this arrangement is the pre-conditioning effect generated by the forward blade in each pair. Similar to how a mainsail benefits from the smooth airflow created by the jib, the forward blade in the staggered-pair propeller serves to condition the water flow before it reaches the aft blade. This pre-conditioning effect can reduce flow separation on the aft blade, which is one of the primary causes of drag and inefficiency in conventional propeller designs. As the water passes over the forward blade, it accelerates and becomes more uniform, allowing the aft blade to operate in a smoother, higher-velocity flow. This results in more efficient thrust production, as the aft blade experiences less turbulence and drag.

Furthermore, the staggered-pair design could lead to smoother pressure fluctuations between the blades, which has the added benefit of reducing cavitation. Cavitation occurs when localized pressure drops below the vapor pressure of the fluid, causing the formation of bubbles that collapse violently, damaging the surface of the blades and reducing overall efficiency. By smoothing out pressure fluctuations between the forward and aft blades, the staggered design could help prevent cavitation, leading to a longer lifespan for the propeller and reducing maintenance costs. Additionally, the reduction of cavitation would contribute to a quieter operating environment, which is particularly important for marine propellers used in recreational and military vessels.

The staggered-pair configuration may also allow for greater efficiency at lower RPMs, a significant advantage in both marine and aerial applications. Similar to how a well-tuned jib-mainsail setup generates more lift at lower wind speeds, the staggered design could help maintain more efficient propulsion at lower rotational speeds. This would be especially beneficial for applications where efficiency at low speeds is critical, such as in cruising or maneuvering, as the propeller would maintain effective thrust without requiring high rotational speeds or excessive power input.

Integration of Slot Effect Research into Propeller Design

Building upon the research of Arvel Gentry and recent advancements in the understanding of the slot effect, particularly in aerorigs and wingsails, the present invention introduces a paradigm shift in propeller engineering. By harnessing the principles of the slot effect and adapting them to rotary propulsion systems, this invention represents a novel approach to optimizing fluid dynamics in propeller blades. In aerodynamics, the slot effect has been used to improve the performance of wings and sails, offering smoother airflow and more efficient use of the surrounding medium. The successful adaptation of this principle to propeller design is expected to improve propulsion efficiency, thrust generation, and reduce drag across a wide range of applications.

However, adapting the slot effect from sails and wings to propellers presents several unique engineering challenges. In a sailboat, the jib and mainsail are typically rigged from a mast that runs fore and aft, and the sails are controlled by sheet lines that adjust their angle relative to the wind. The mast is perpendicular to the deck of the boat, providing a fixed reference for the positioning and movement of the sails. Propellers, in contrast, have blades that radiate outward from a central hub, and each blade is positioned at an angle relative to adjacent blades. This geometric difference between sails and propeller blades creates a more complex relationship between the forward and aft blades in the staggered design, which must be carefully optimized to ensure the desired flow conditioning and reduction in drag.

The challenge is not only to configure the blades in a staggered fashion but to adjust their individual characteristics—such as rake, skew, pitch, and chord length—so that they work together efficiently, creating a balanced flow of water through the propeller system. Furthermore, the design must account for the variable conditions of the medium, whether it be water for marine propellers or air for aerial propellers, and adapt to different operational environments. The innovation of the present invention lies in its ability to integrate the principles of the slot effect in a way that optimizes the fluid dynamics of rotary propulsion systems, while overcoming the inherent differences between sails and propellers.

Challenges in Adapting Slot Effect Research from Sails to Propellers

The task of adapting the research on the slot effect from sails to rotary propulsion via propellers is further complicated by the fundamental differences between the two systems. Studies on the slot effect have primarily focused on the interaction of airflow around soft fabric sails, while propellers typically feature rigid blades that rotate through a solid medium, such as water or air. The properties of water and air are notably different, and these differences present significant challenges in transferring principles from one medium to another.

In particular, hydrodynamic propulsion relies on the movement of water around rigid blades, and water's physical properties impose several unique challenges compared to air. The following differences between water and air are key to understanding the difficulties of applying the slot effect in sail design to propeller engineering:
1. Density: Air is significantly less dense than water. At sea level, the density of air is around 1.2 kg/m³, while the density of water is approximately 1000 kg/m³. This drastic difference in density affects the behavior of fluid flow. Water's higher density means that there is more resistance to motion, as it takes more energy to move the same volume of water compared to air. The greater inertia of water also leads to slower responses in flow adjustments, which makes optimizing flow patterns in water more complex than in air.
2. Viscosity: Water is far more viscous than air. Viscosity refers to a fluid's resistance to flow, and higher viscosity means there is greater friction between layers of fluid and solid surfaces. In water, this increased viscosity results in greater resistance to the movement of the blades, leading to more energy being dissipated as friction. This is in contrast to air, where lower viscosity allows for smoother flow and less drag on surfaces like sails or wings. As a result, the dynamics of fluid flow and the potential for flow separation, a key factor in propeller efficiency, behave differently in water than in air.
3. Compressibility: Air, as a gas, is compressible, meaning its density can change with variations in pressure. Water, on the other hand, is nearly incompressible under typical conditions. The compressibility of air allows for phenomena like shockwaves and other dynamic effects, which are not typically observed in the flow of water. This compressibility also impacts the behavior of airflow when it interacts with surfaces, such as when a jib and mainsail work together to create a slot effect. In water, the nearly incompressible nature of the fluid means that the flow dynamics are constrained by more rigid physical properties, requiring different strategies for optimizing flow.
4. Thermal Properties: Air and water also differ significantly in their thermal properties. Air has a lower thermal conductivity compared to water, meaning that it heats up and cools down more rapidly when subjected to changes in temperature. This difference in thermal properties leads to variations in fluid density and flow patterns between the two media. For example, temperature fluctuations in water may have a more gradual effect on its density compared to the rapid changes observed in air. This slower response to thermal changes in water requires propeller designs to be more resilient to varying environmental conditions, whereas designs for sails or wings in air may be more sensitive to these changes.

These fundamental differences between water and air create significant challenges when attempting to apply the slot effect—originally studied in the context of sailboats—to rotary propulsion systems like propellers. While the principles of flow optimization and smooth transitions between blades remain relevant, the unique properties of gas (e.g., air) and liquid (e.g., water) require the adaptation of these ideas to account for the distinct fluid dynamics involved in both aerodynamics and hydrodynamics. The present invention takes into consideration these critical differences and adjusts the traditional concepts of the slot effect to accommodate the behavior, respectively, of air water around relatively rigid blades, aiming to improve efficiency and reduce drag in both aerial and marine applications.

### Differences in Scale, Shape, and Velocity Between Sails and Propeller Blades

In addition to the distinctions between the medium in which sails on a sailboat and propellers in marine or aerial environments operate, there are also significant differences in scale, shape, and velocity that impact the way these systems interact with their respective fluids. The sails on ocean-going sailboats, for instance, often range from 50 to over 100 feet in height and 20 to 30 feet in width. These sails are typically triangular in shape, designed for practical reasons such as fitting a jib between a forestay and a rigid mast and a mainsail between a mast and a boom. These large, flexible surfaces harness the kinetic energy of the wind to create lift, generating aerodynamic forces that propel the sailboat forward.

In contrast, the blades of a propeller, whether used in a marine or aerial application, are typically much smaller in size, often ranging from a few inches to several feet in length and varying in width from an inch to a few feet. In FIG. 6, the propeller blades of a typical aerial drone are shown. The blades are rigid structures that rotate through a fluid medium and are designed to generate thrust through their movement. While sails rely on the wind to provide the necessary force for propulsion, propellers work by pushing against a much denser and more viscous medium (in the case of marine propellers) or generating lift in the air (in the case of aeronautical propellers). The structural differences between sails and propellers are crucial when designing for optimal propulsion, as these differences determine how forces are transmitted and how efficiently the system can convert energy into motion.

Implications of Fluid Interactions: Air Vs. Water

The importance of these differences becomes clear when considering how sails and propellers interact with their respective media. The lower density and viscosity of air make it more responsive to the forces exerted by sails. When wind flows over the curved surfaces of a sail, the sail's shape and angle of attack allow it to harness the energy from the moving air to generate lift and, consequently, propulsion. The lighter air creates a more dynamic interaction between the sail and the wind, where the forces exerted by the sail significantly influence the motion of the vessel.

On the other hand, water is far denser and more viscous than air. The higher density and viscosity of water result in greater resistance to motion, which means that more energy is required to move a vessel through the water. This resistance is why propellers must be designed to overcome drag and maximize thrust. Propeller blades are shaped, pitched, and positioned to optimize the interaction with water, taking into account factors such as the angle of attack and rotational speed. Unlike sails, which rely on the pressure differences created by the flow of wind across a flexible surface, propellers must generate thrust by pushing against the water in a way that minimizes drag and optimizes fluid flow around the blade surfaces.

Thus, the design of propeller blades must consider not only the basic principles of fluid dynamics but also the challenges posed by water's properties. Marine propellers, like those used in boats or submarines, are especially influenced by water's higher density and viscosity, requiring more precise engineering to ensure that the propeller functions efficiently in this challenging environment. The principles of sail aerodynamics, while useful in understanding the slot effect, must be adapted to account for these differences when designing propellers for water-based propulsion systems.

Biomimicry in Propeller Design: Inspiration from Canadian Geese and Dragonflies

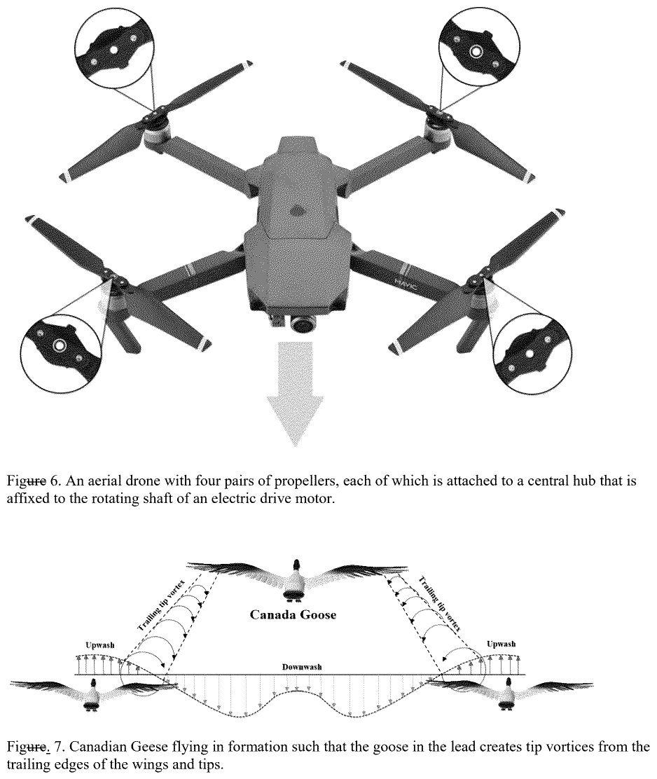

The present invention draws from recent advances in biomimicry, specifically taking inspiration from the natural world to improve propeller design. One of the most notable examples of biomimicry is the behavior of Canadian Geese during migration. As they fly in formation, the lead goose generates tip vortices from the trailing edges of its wings and wing tips. These vortices create an upwash that provides lift for the birds following in the formation, allowing the entire flock to conserve energy and maintain more efficient flight. This fascinating natural phenomenon, shown in FIG. 7, involves the interaction between the flow dynamics of the lead bird's wings and the lift provided to subsequent birds. The principle of this aerodynamic interaction—where the leading bird conditions the air for the birds behind it—can be applied to the design of propellers. In a similar way, the forward blade in each pair of a staggered-pair propeller design conditions the flow for the aft blade, creating a smoother, more efficient water or air flow, thus reducing drag and improving performance.

By applying this principle to propeller design, the present invention leverages the relationship between the forward and aft blades of a propeller pair, analogous to the way geese in formation benefit from the airflow created by the lead bird. This arrangement enables the aft blade to operate in a smoother, more energy-efficient flow, improving overall thrust and reducing resistance, much like the geese benefit from the vortices and upwash generated by the lead goose. The staggered-pair configuration mimics this natural effect, creating an optimal aerodynamic or hydrodynamic environment between blades, ultimately enhancing propulsion efficiency.

### Dragonfly Flight and the Application to Propeller Design

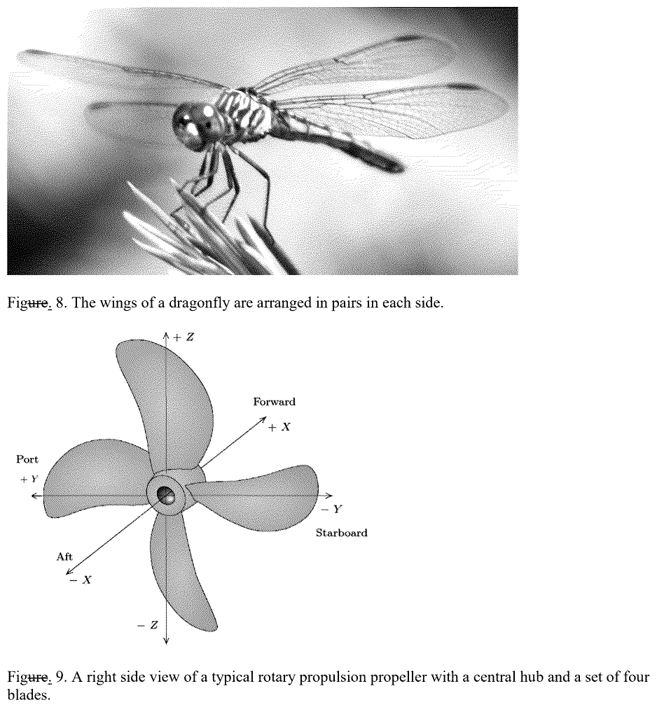

Further advancing the concept of biomimicry, the present invention also incorporates insights from the study of dragonfly flight. As shown in FIG. 8, dragonflies have evolved a unique wing configuration in which the wings on each side of their bodies are arranged in pairs. When dragonflies glide, the forward wing of each pair can be adjusted to create a slot effect with the aft wing. This interaction between the wings creates an aerodynamic advantage by directing airflow efficiently over the wings and reducing drag, thereby improving the dragonfly's ability to glide and maneuver with minimal energy expenditure.

Inspired by this, the present invention adapts the principles of dragonfly flight to propeller blade design. By configuring the forward and aft blades of a propeller in a similar manner to dragonfly wings, the invention creates a slot effect between the blades. This interaction optimizes the airflow or water flow between the blades, enhancing the performance of the propeller. The ability to adjust the relative position and configuration of the blades in a staggered-pair arrangement allows for smoother transitions of fluid flow, reducing turbulence and increasing efficiency.

### Surface Texture Enhancements Inspired by Nature

In addition to the aerodynamic principles drawn from nature, the present invention also applies the concept of surface textures found in nature to further enhance propeller performance. Many animals, including fish, birds, and other flying or swimming creatures, have developed unique surface textures, such as scales or ridges, that reduce drag and enhance their ability to move efficiently through water or air. For example, fish scales or the feathers of birds often exhibit patterns like crescent-shaped scales, overlapping diamonds, parallelograms, and triangles, which serve the dual purpose of decreasing the surface tension between the moving medium (water or air) and the creature's body, while also minimizing resistance.

Building on this principle, the present invention integrates similar textures into the design of propeller blades. By incorporating artificial patterns that mimic these natural shapes and textures, such as crescent-shaped scales or overlapping geometric patterns, the propeller blades can experience reduced friction with the surrounding medium. This reduction in surface tension leads to smoother fluid flow over the blades, further reducing drag and enhancing propulsion efficiency. The use of textures not only improves performance but also extends the lifespan of the propeller by reducing wear and tear on the blade surfaces due to decreased friction with the air or water.

### DETAILED DESCRIPTION OF THE INVENTION

At the core of the present invention is a novel adaptation of the aerodynamic slot effect—traditionally observed between a jib and mainsail on a fore-and-aft-rigged sailboat—to rotary propulsion systems. This is achieved through the unique configuration of staggered blade pairs, in which a forward blade and an aft blade are arranged around a central hub in such a manner as to form a functional aerodynamic or hydrodynamic slot between them.

In a representative embodiment of the invention, each pair of blades comprises two distinct elements: (1) a forward blade mounted closer to the leading edge of the propeller's direction of rotation and axial flow, and (2) an aft blade mounted slightly behind and radially offset from the forward blade. These blade pairs are strategically staggered both radially and circumferentially around the hub to form an angular displacement between the blades in each pair. This arrangement enables a controlled interaction between the flow field of the forward blade and that of the aft blade, creating a slot through which the fluid (air or water) is drawn, accelerated, and directed onto the suction side of the aft blade.

This staggered configuration is not merely a passive structural arrangement. It facilitates a dynamic slot effect during rotation, in which the pressure differential across the forward blade induces a localized increase in flow velocity through the slot, effectively preconditioning the flow that impacts the aft blade. As a result, the aft blade operates in a region of smoother, faster-moving fluid, increasing its lift-to-drag ratio and enhancing overall thrust. This mechanism reduces energy losses from turbulence and flow separation, improving propulsion efficiency, particularly at lower RPMs or under high-load conditions.

Structural Framework and Comparison with Conventional Propellers

To understand the distinctive features of the present invention, it is helpful first to consider the anatomy of a conventional propeller. As shown in FIG. 9, a typical propeller consists of a central hub with a forward end and an aft end aligned along the longitudinal X-axis. The blades are mounted radially on the hub, typically along axes extending from the center outward in the Y and Z directions. In traditional designs, all blades are spaced evenly around the hub, with symmetrical pitch and orientation.

The present invention departs from this configuration by introducing asymmetry in the radial and angular placement of the blades. Instead of equidistantly spaced blades with identical pitch, this invention features staggered sets of blades—each pair consisting of a forward and aft blade—that are offset to produce the slot effect described above. The angular offset, axial separation, and chordwise alignment between the forward and aft blades are tuned to optimize flow conditions and maximize propulsion efficiency.

### NOVEL ASPECTS RELATIVE TO PRIOR ART

The key distinctions between the present invention and conventional propeller designs include:
1. Blade Pairing and Staggering: Traditional propellers do not incorporate blade pairs aligned to induce controlled slot flow between them. The present invention positions blades in pairs with intentional forward-aft staggering to replicate the benefits of slot aerodynamics in a rotating system.
2. Flow Conditioning: Unlike conventional blades, which encounter unmodified fluid flow, the aft blade in each pair benefits from flow preconditioned by the forward blade. This reduces flow separation and cavitation while increasing thrust.
3. Slot Geometry Optimization at the Outer Portion of Longer Blades: The spacing and angular orientation of the slot are critical to its effectiveness. Adjustments to blade thickness, chord length, and axial separation allow the slot to maintain laminar or transitional flow between blade surfaces, enhancing efficiency.
4. Biomimetic Inspiration: The staggered-pair design mirrors natural propulsion systems, such as the wing formations of geese or the paired wings of dragonflies. This bioinspired configuration is specifically adapted to rotary propulsion, which has not been addressed in the prior art in this manner.

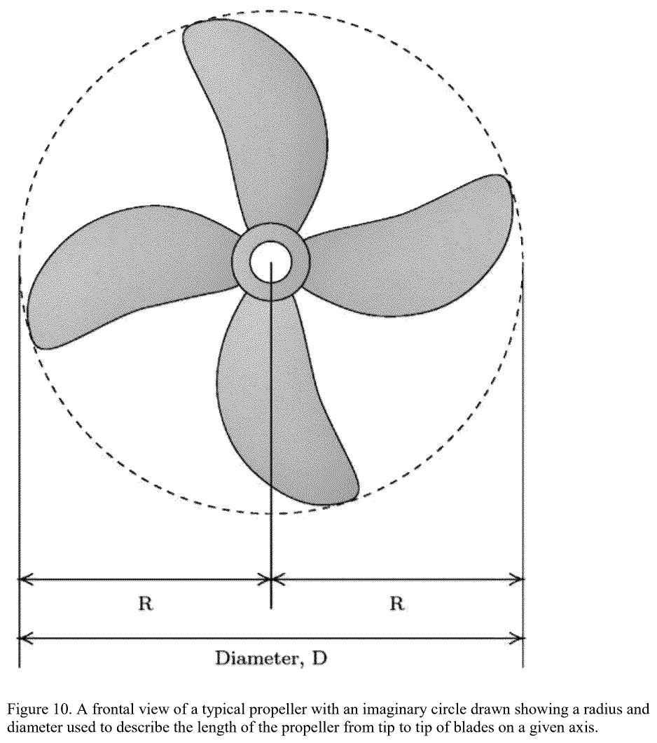

In FIG. 10, a typical propeller is shown in frontal view, with an imaginary dashed circle connecting the tips of all blades. This circle defines the circumscribing circle of the propeller, and its radius—measured from the center of the hub to the tip of a blade—indicates the radius of rotation. The diameter, which spans from tip to tip of opposing blades along a given axis, provides a basic geometric measure of the propeller's overall size.

As the propeller rotates through a fluid medium such as air or water, each blade tip traces a circular path along this radius. The propeller's pitch—the theoretical distance it would advance in one complete revolution assuming no slippage—governs how far the vessel or aircraft moves forward per rotation. For instance, a propeller with a pitch of 17 inches is theoretically capable of moving forward 17 inches per revolution. In practice, however, slip (the difference between theoretical and actual advance) occurs due to factors such as medium resistance, turbulence, and blade efficiency. The extent of slip depends on the propeller design, fluid properties, and operating conditions.

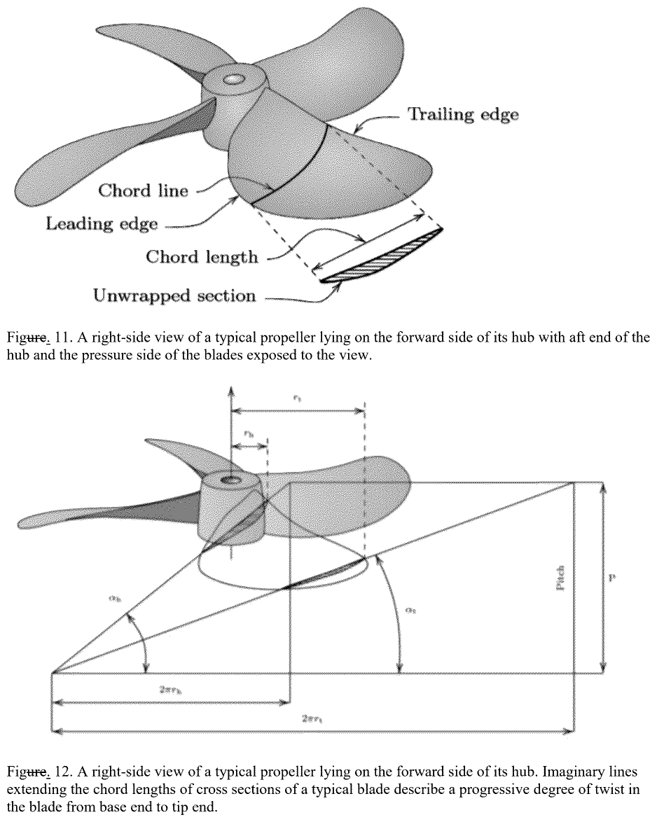

In FIG. 11, the aft-facing side (also known as the pressure face) of a conventional propeller is shown. An imaginary reference line is drawn along the face of one blade, indicating the location of a transverse cross section. This cross section reveals the airfoil shape of the blade, with a clearly defined leading edge (the part of the blade that first encounters the fluid) and trailing edge (where the fluid exits the blade surface).

The distance between these two points in the cross section is known as the chord length. In many conventional designs, the chord length varies along the blade's span: it is shorter near the blade's base and tip, and longer around the midpoint. This distribution contributes to the desired thrust characteristics and controls how forces are distributed along the blade. FIG. 12 depicts a conventional propeller from the starboard side, with the hub lying flat so that the aft-facing blade surfaces (also called the suction faces) are visible. Two imaginary cross-sectional planes are illustrated—one near the base of the blade and another closer to the tip. Each plane defines a cross section through the blade at a different radial distance from the hub.

The angle formed between each cross section and a line parallel to the longitudinal axis of the hub defines the local pitch angle. Near the base, the pitch angle is relatively steep, allowing for more aggressive fluid engagement. Near the tip, the pitch angle becomes shallower. This continuous change in pitch angle from root to tip—referred to as blade twist—is critical for maintaining uniform thrust along the span of the blade, given the varying tangential speeds during rotation.

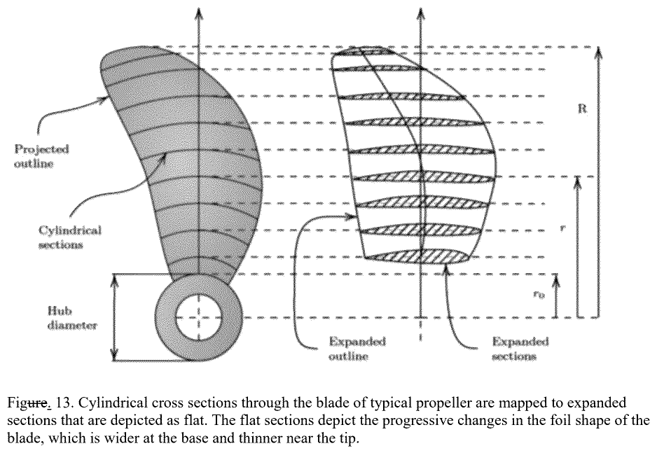

In FIG. 13, the geometry of a conventional blade is analyzed through a set of imaginary cylindrical surfaces concentric with the hub. At each radial position, the curved intersection between the cylindrical surface and the blade defines a local blade profile.

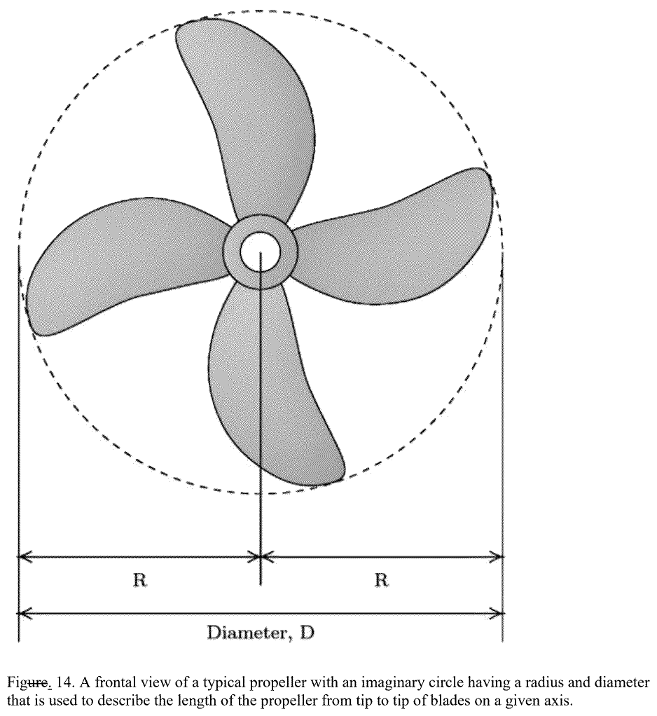

In FIG. 14, the figure of an imaginary circle is shown touching the tips of the propeller blades. A radius of the circle describes the distance from the center of the hub to the tips of the blades. The diameter describes the distance from tip to tip of blades on the same axes.

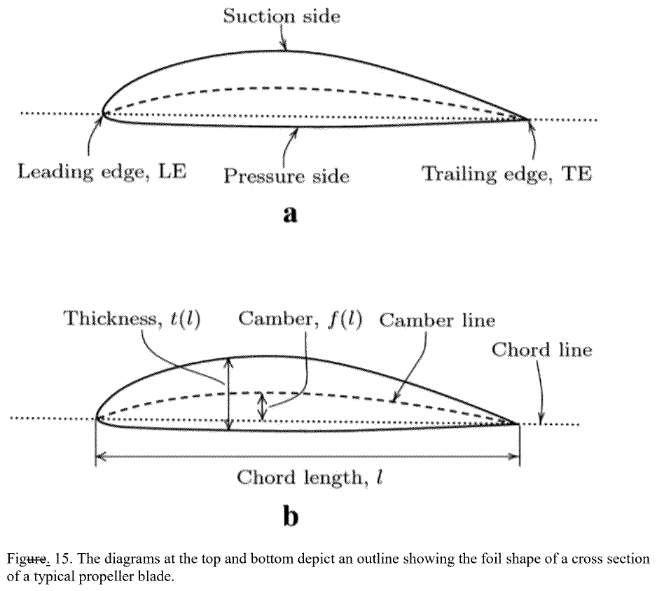

In FIG. 15, the two diagrams depict an outline of the same cross section through a propeller blade. The upper diagram, labelled a, describes an outline of the cross section of the blade, and the labelled arrows indicate the leading and trailing ends of the blade as well as the suction (herein also called the back) side and pressure (herein also called the face) side of the blade. The lower diagram in FIG. 15, labelled b, describes an outline of the cross section of the blade, and the labelled arrows indicate the thickness, the chord line and the chord length, as well as the camber of the blade.

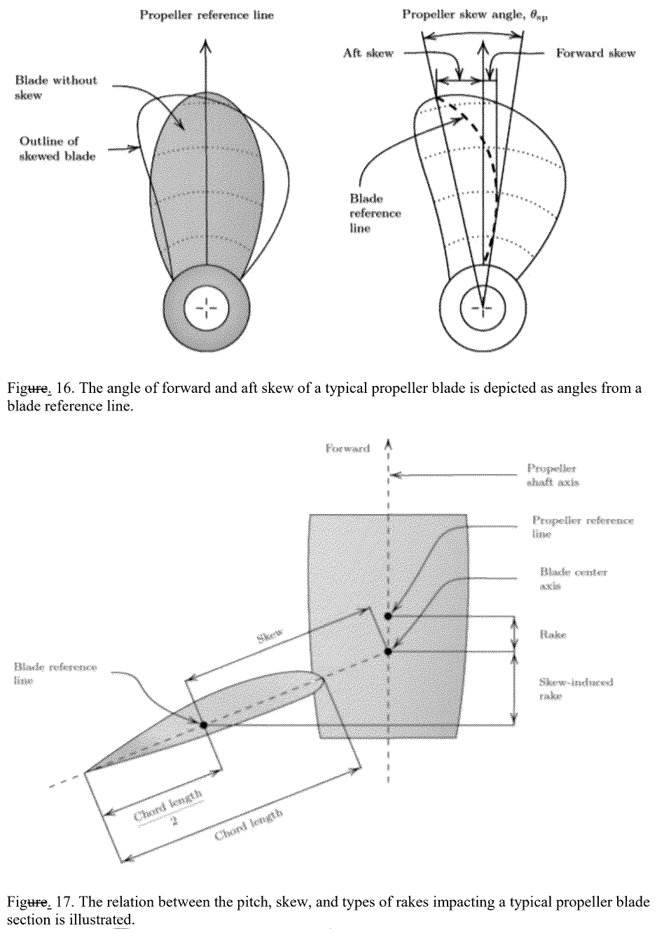

In FIG. 16, the relationships between the propeller shaft axis, the propeller reference line, the blade reference line, and the blade center axis are depicted for one blade of a typical propeller. Note how skew and rake affect the distance between the axes. The propeller rake is characterized as the displacement of the radial foil section along the shaft. Displacements in the aft direction are considered as a positive rake, and the rake measured at the blade tip is frequently used as a rake measure. The rake comes from two components, namely the initial rake and the skew-induced rake. The skew-induced rake is an axial displacement caused by the skew imposed on a blade section.

Several parameters of blade shape and configuration are important for the present invention. These include geometric relationships between several reference lines relevant to blade orientation and performance: the propeller shaft axis (aligned with the center of rotation), the propeller reference line (typically a radial plane normal to the shaft), the blade reference line (a radial line along the blade root or chord), and the blade center axis (following the midline or aerodynamic center of the blade section).

FIGS. 16 and 17 illustrate how skew and rake alter the blade's spatial configuration relative to these axes. Skew displaces the blade tangentially, while rake shifts the blade axially along the shaft direction. Rake is commonly defined at each radial section, with the tip rake often used as a summary measure. Rake values are positive when the blade tips are displaced in the aft direction, trailing behind the reference plane. These components influence aerodynamic and hydrodynamic loading, pressure distribution, and cavitation resistance, particularly in high-speed applications. These parameters are grounded in the geometry of the chord line and mid-chord point, which serve as central reference features for blade section analysis.
Pitch refers to the axial advance a propeller would make in one full rotation assuming zero slippage and is geometrically expressed by the helix angle of the blade section.
Skew influences both mid-chord orientation and effective rake due to tangential displacement.
Rake, as noted, contributes an axial displacement that modifies the blade's attack angle and affects both efficiency and cavitation threshold.

Importantly, rake includes two components:
Initial rake, introduced in the blade's design as a constant axial displacement.
Skew-induced rake, which arises from the tangential sweep of skewed blades; this sweep results in varying axial positions across the chord due to blade curvature.
Blade area ratio (BAR) and comparative efficiency across different blade configurations.

A low BAR propeller has relatively narrow blades and is typically optimized for speed and efficiency in low-load applications, but is more prone to cavitation at high loads. A high BAR propeller has wider blades, offering more surface area to distribute hydrodynamic forces and is generally preferred in high-thrust or heavy-load applications.

Together, these variables define the orientation and motion path of each foil section, affecting how the blade slices through a fluid medium producing thrust.

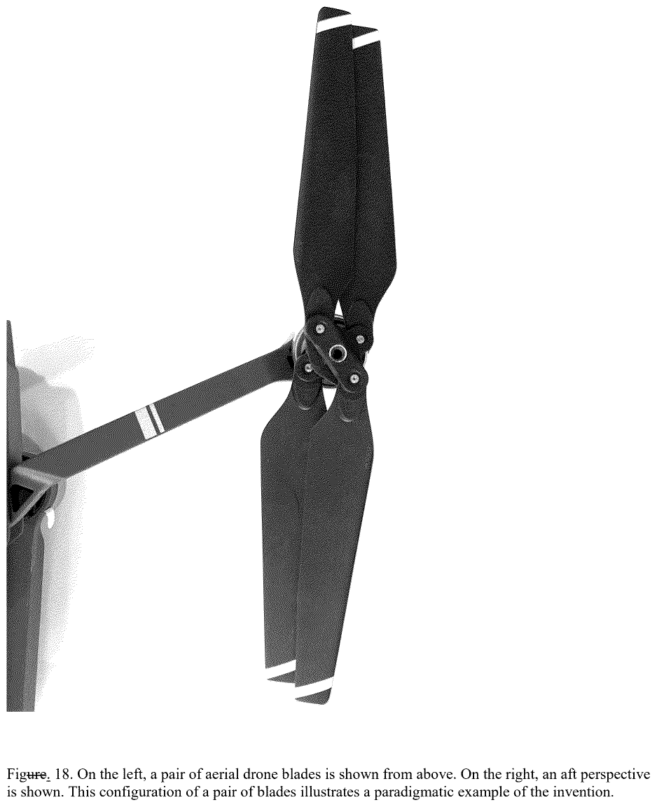

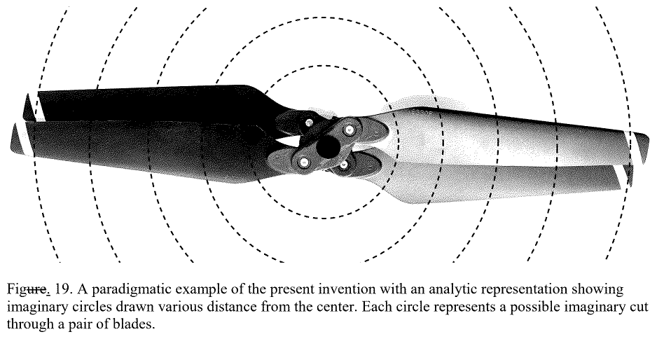

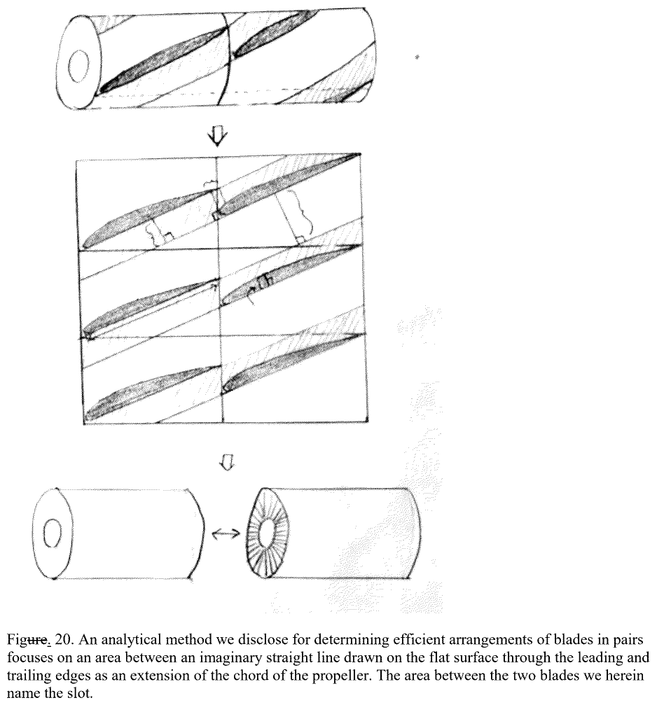

The present invention includes the configuration of blades for aerial drones, helicopters airplanes wherein the blades are configured such that there are pairs of blades, one forward and above the aft propeller, as show in FIG. 18. The present invention is described herein by taking a cut a given distance, and then treating is having been mapped to a flat surface, as illustrated in FIG. 19. In this fashion we describe the relative positions of the forward and aft blades of each pair in relation to one another.

In FIG. 20, the forward blade of a pair of aerial drone propellers is configured to be above the aft blade of the pair. Viewed from the above, the two blades in this figure overlap one another by a proportion that is approximately a one-fourth to one-third of the surface area of the top of each blade. The spatial arrangement of the blades creates an effective slot effect between the two. Viewed from aft of the pair of blades, which is shown in the illustration on the right, the slot between the two blades enables the air passing below the underside of the forward blade to be accelerated in a laminar flow as it then passes over the top side of the aft blade as the propellor rotates and the air moves over the blades. When each pair of propellers in this configuration spins around a central point, the forward blade helps to power the aft blade by speeding and directing the flow of air between the two. The effect is like the passage of air through a slot between the jib and main sails of a sailboat.

In the present invention, the slot is typically diagonal. Propeller blades are typically designed with a twist to accommodate the differences in velocity of the various portions of the blade as the propeller spins. In a paradigmatic embodiment of the present invention, the forward and aft blades of a pair are aligned for a proportion (e.g., ½ the length, or ¾ of the length, or all of the length) of the blades. The alignment may include the leading edges, the trailing edges, the faces, the chords from leading to trailing edge, the shapes of the airfoils. The present invention embodies and effective slot between the two blades of a pair. The blades are staggered, fore and aft, but they may overlap in some degree, or there may be a separation between the trailing edge of the forward blade and the leading edge of the aft blade of a given pair.

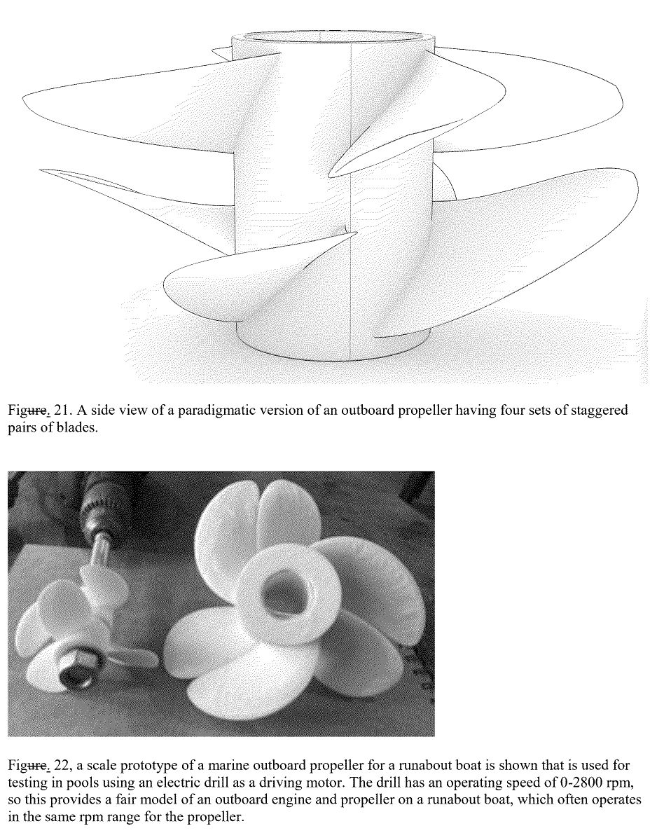

Prototypes of the present invention for both marine and aerial applications have been tested at a range of scales. In FIG. 21, a side view of a paradigmatic version of an outboard propeller having four sets of staggered pairs of blades is shown. In FIG. 22, a small-scale prototype of a marine outboard propeller for a runabout boat is shown. Direct comparisons of the forward blade alone and staggered pairs of blades have been conducted. Using propellers with staggered blades configured on separate forward and aft hubs allows for testing of propellers having the same blade sizes and shapes, and it allows quick adjustments of the separation between the forward and aft hubs and blades by the simple insertion of one or more thin washers between the hubs. This setup also enables comparisons of a wide range of angles between the trailing edge of the forward blade and leading edge of the aft blade.

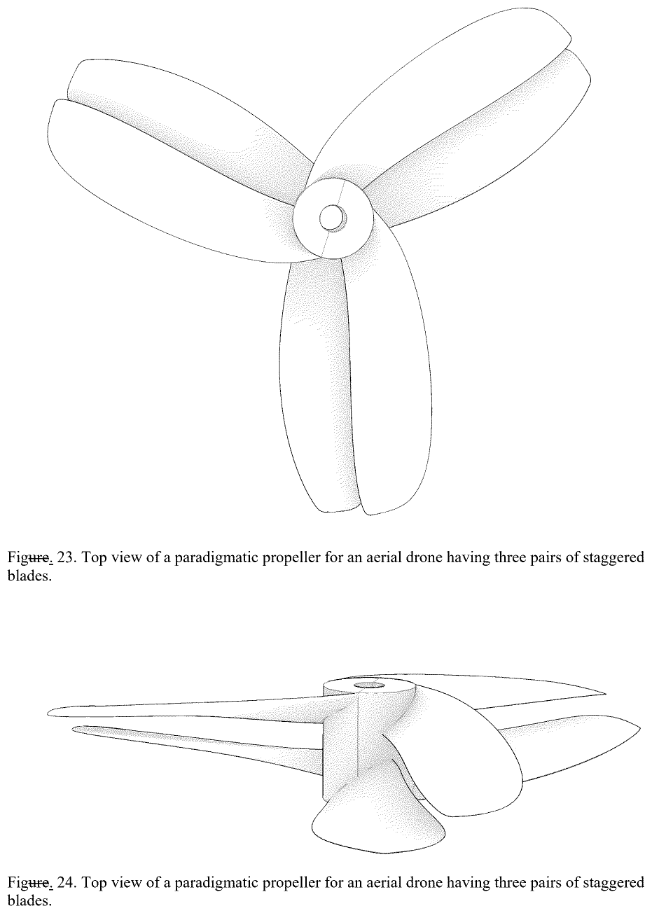

FIGS. 23 and 24 illustrate a paradigmatic example of the present invention applied to the case of aerial drone propellers. In this example, the propeller has three pairs of staggered blades. The designs illustrated in the figures illustrate the key parameters of relative rake and skew of forward and aft blades to maintain proper alignment for efficient flow of air through the effective slot between the blades. In this case, rake and skew are largely achieved at the base of each blade. The forward blade is dramatically skewed aft in this example, and the aft blade is dramatically skewed forward. The enables the proper alignment of the two blades of the pair in the inner ⅓, middle ⅓ and outer ⅓ portions of each blade.

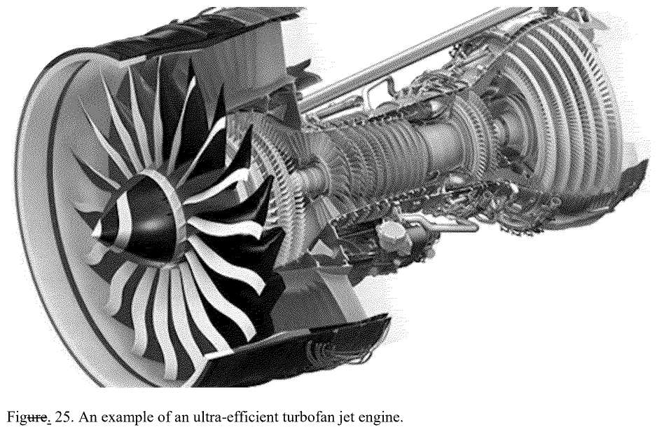

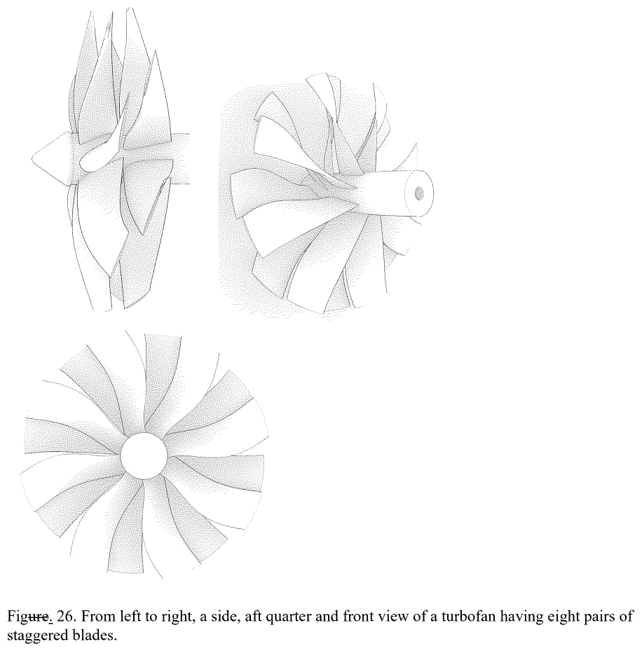

The present invention is being applied to the design of turbo fans for jet engines. FIG. 25 shows an example of an ultra-efficient turbofan jet engine. The design has 16 blades which are arranged all in the same plane of rotation with no staggered blades. We have developed, prototyped and tested turbofans having staggered pairs of blades based on the present invention. In FIG. 26, a design with 16 blades arranged in staggered pairs are shown in a frontal, aft quarter and side view. These three views disclose the several features of the present invention applied to the case of turbofan designs. For each pair of blades, the trailing edge of the forward blade is aligned with the leading edge of the aft blade. The forward blade has a pitch that is a small amount less than the aft blade. The blades of each pair have complementary foil shapes, curvature, rake and skew, and the two blades of each pair are staggered with a small amount of separation at the outer portion of the out third of the blades in a manner that is well adapted for efficient flow through a highly effective slot between the two blades and around the blades of each pair.

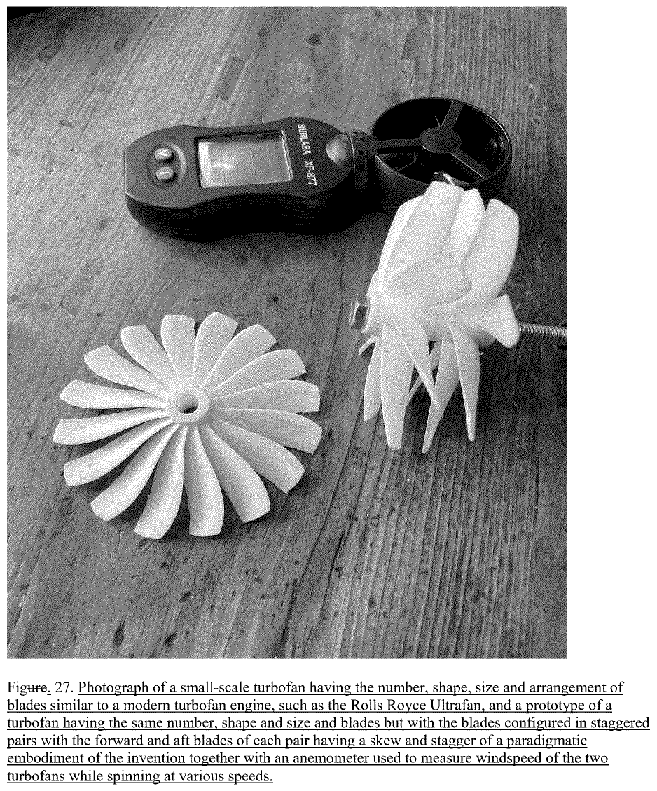

Prototypes of these designs for turbofan propellers have been empirically tested. The tests directly compared 16 blade designs having all blades arranged in the same plane axially to propellers having 16 blades arranged in staggered pairs, as show in FIG. 27. The results showed that the propellers with staggered pairs of blades are dramatically more efficient and produced considerably more thrust at the same rpms. This is remarkable because the tests compared propellers having the same number of blades, blade areas, foil shapes, and the like.

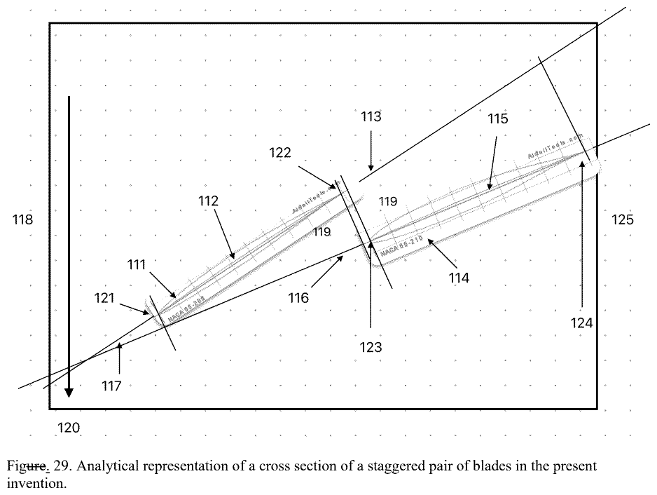

FIG. 29 below further discloses key elements of the present invention. Here, a marine outboard propeller is shown with four pairs of blades arranged symmetrically around a central hub. Each pair consists of a forward blade and an aft blade in a staggered configuration, offset axially (along the shaft) and radially (around the hub) to generate a slot effect-a channeling phenomenon modeled after the interaction between sails in a sloop rig.

In this embodiment:
The leading edge of the forward blade precedes that of the aft blade in the direction of rotation and propulsion.
The trailing edge of the aft blade extends beyond that of the forward blade, capturing and accelerating fluid flow initiated by the first.

This alignment is carefully engineered to exploit the interaction between the pressure field on the face side of the forward blade and the back side of the aft blade. As the propeller rotates, the medium (air, water, or other fluid) is directed into the slot between these surfaces, where it is accelerated in a manner analogous to the slot effect between a jib and mainsail. The result is enhanced flow cohesion, higher local velocity, and improved thrust with reduced cavitation and energy loss.

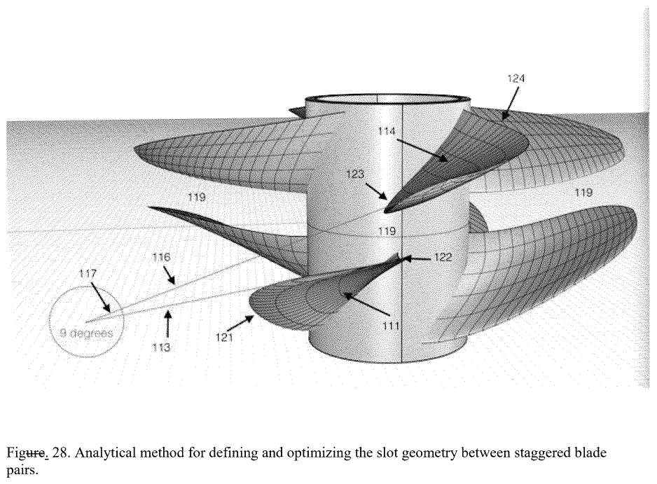

FIG. 28 illustrates a central method disclosed in this invention for determining efficient arrangements of propeller blades in staggered pairs. The analysis begins with an imaginary straight line drawn along the flat analytical surface of each blade section, connecting the leading and trailing edges to form an extended chord line. The area bounded between the extended chord lines of the forward and aft blades of each pair is herein referred to as the slot.

In typical embodiments of the invention, the slot is diagonally oriented reflecting both the axial and tangential displacement between blade pairs. This diagonal slot arises naturally from the twist imparted to propeller blades to accommodate radial variations in tangential velocity during rotation. Unlike conventional propeller blades, which operate in relative isolation, the present invention intentionally aligns portions of the forward and aft blades in each pair to produce a controlled interaction within the slot.

In a paradigmatic embodiment of the present invention, the forward and aft blades are aligned along a specified proportion of their span—e.g., in the inner, middle or outer thirds of each blade or the full length of the blade. Alignment may occur at several structural or aerodynamic features, including:
Shape and relative position of leading edges/
Shape and relative position railing edges
Relative position of blade faces (pressure or suction side)
Chord lines from leading to trailing edge
Airfoil profiles
Location and degree of cupping of blades
Relative chord length of fore and aft blades at inner, middle and outer sections of each blade
Patterns biomimetic textures and shapes on blade surfaces
Relative length of fore and aft blades
Pitch fore and aft blades

While the blades are staggered—with the forward blade leading the aft blade in both axial and circumferential directions—they may also exhibit some overlap or separation depending on performance optimization goals. In some configurations, the trailing edge of the forward blade may nearly touch or partially overlap the leading edge of the aft blade, whereas in others, a deliberate gap is maintained to enhance slot effect dynamics.

### Flat Analytical Projection of Cylindrical Blade Sections.

In this analytical framework, the blades are mapped from their cylindrical surface onto a flat plane, which provides a clear depiction of geometrical features without occlusion by the hub or other blades. This is achieved by projecting cross sections through the blade at uniform radial distances-specifically at locations that are at ⅙, ⅓, ½, ⅔, ⅚, etc. ratios of the distance from the base (at the hub) to the blade tip.

Each cross section captures the orientation and profile of the blade at a distinct height, enabling precise comparisons of:
Thickness
Chord length
Twist
Curvature
Airfoil profile and camber
Distance between the chords of each blade
Amount of stagger or overlap between the forward and aft blades

In FIG. 29, these projected profiles make visible the continuous changes in blade geometry along the span, which are characteristic of most high-efficiency propeller designs. In this figure, which nicely represents a paradigmatic configuration of two blades at the outer third portion of the two blades. Similar relationships would be found in paradigmatic embodiments in the inner and middle third portions of the two blades of the pair. In the paradigmatic embodiment illustrated in this figure, the two blades have a small degree of difference in thickness, with the forward blade being slightly thinner than the aft blade. The chord lengths of the two blades are similar, with the forward blade being slightly shorter than the aft blade. The curvature of the two blades is complementary, as are the airfoil profile and camber. In this embodiment, the distance between the chords of the two blades as measured at a straight line drawn at the leading edge of the aft blade and perpendicular to the chord line of the aft blade is greater than the thickness of either blade. In this paradigmatic embodiment, the distance between the two blades is approximately 5× the thickness of the aft blade. The separation between the two blades in the fore and aft direction of the chord lines is measured between a line drawn perpendicular to the trailing edge of the forward blade and another line drawn from the leading edge of the aft blade. In this paradigmatic embodiment, the separation between the two blades is small, being only a small portion of less than 1/10 as a ratio of the length of either blade of the pair.

In order to realize efficient flow through the slot between the two blades, the distance between the chord lines will typically be between 1× and 20× the thickness of the aft blade for a paradigmatic embodiment of the present invention. The separation will typically be less than a ration of ¾ the length of the aft blade for a paradigmatic embodiment of the present invention.

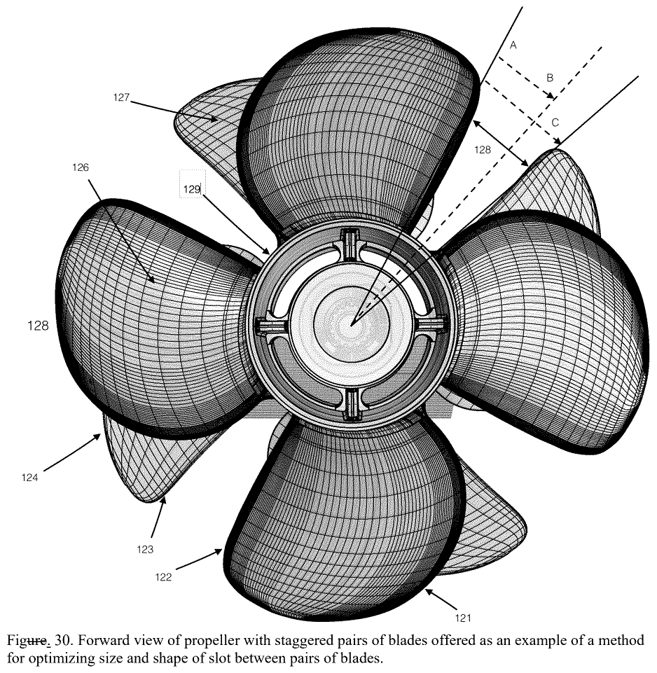

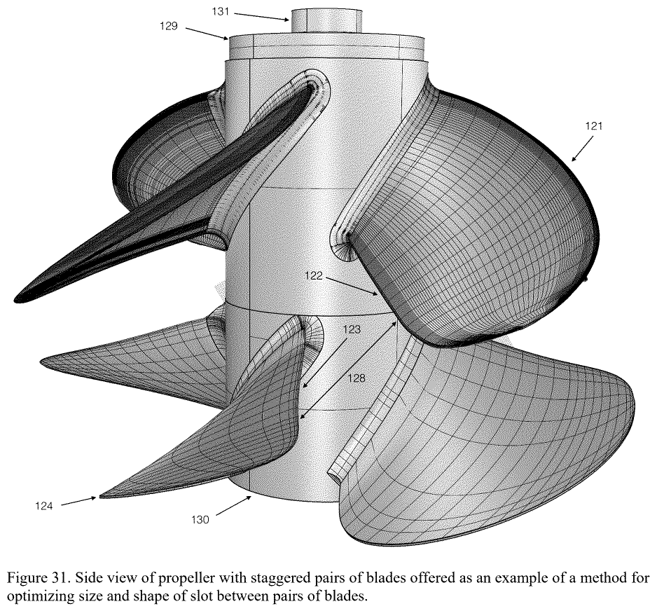

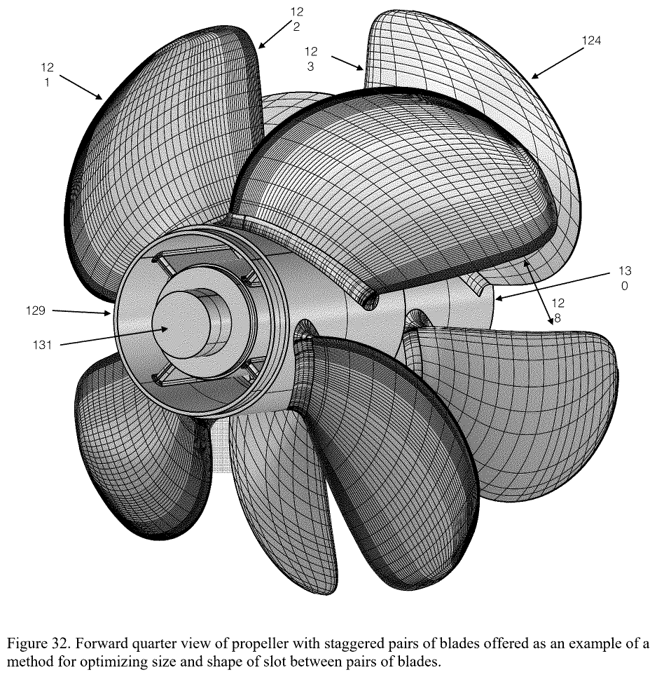

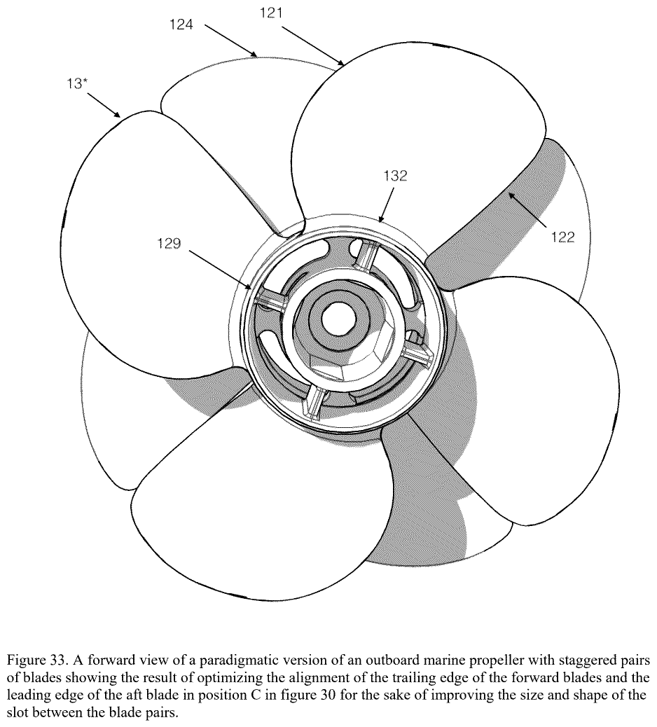

In FIG. 30, an aft view of a marine outboard propeller having four pairs of staggered blades is shown. This design conveys blades that have a paradigmatic embodiment of blade skew for both the forward and aft blades. The trailing edge of the forward blade and leading edge of aft blades of the staggered pairs are not well aligned to optimize the flow of fluid through the slot. This is further shown in FIG. 31, which provides a side view of the same propeller, and in FIG. 32, which shows a quarter front view. For the sake of clarifying our disclosure with respect to optimizing the efficient flow of fluid through the slot as the propeller spins radially, the separation distance between the trailing edge of a forward blade and the leading edge of the aft blade two blades should be narrowed to better embody a design with optimized flow of fluid through slot and around the blades.

That is, if the current alignment in FIG. 30—where the alignment of the trailing edge of a forward blade of is shown as line A, then the flow through the slot may improve if the forward blades are rotated the same degree, shown as a position between lines B and C for one pair of blades in this example. The rotation to line B is approximately 14 degrees, and to line C, about 20 degrees (± a couple of degrees). What is accomplished by the rotation of the forward set of blades of the pair relative to the position of the aft set of blades is not merely a reduction in the separation between trailing edge of a forward blade and the leading edge of the aft blade. What is more important is optimizing the size and shape of the slot between the blades for efficient flow of fluid between and around the pair of blades, and this is achieved by aligning the blades, including the blade chords and the blade midlines, given the blade thickness of a given pair for the fluid medium in which the propeller is moving. In this case of an example of an outboard marine propeller, given that water is incompressible, the propeller should be designed and constructed with a slot having a proper width and shape to allow efficient movement of the water between and around each of the four pairs of blades of the propeller.

Referring to the cross sections of a pair of blades shown in FIG. 29, the area marked 119 indicates the slot area. If we measure the slot width perpendicularly to the chord of the aft blade (shown as line 114), the width at the leading edge appears to be about twice the thickness of the aft blade. Naturally, this slot-to-thickness ratio may vary along the blade length-often being narrower near the root and wider toward the tip, where the blades are thinner or varying base on the shape of the forward and aft blades. In the design shown in FIG. 31, we estimate the slot width to be: ˜1-2× blade thickness at ¼ length from the root, ˜2× at mid-span, ˜3× at the outer ¾ span in the outer third portion of the blades where they move fastest. Again, it is at the outer third portion that the alignment of the blades of a pair is especially important. One goal of rotating the aft blades of the designs shown in FIGS. 30, 31 and 32 is to optimize the size and shape of this slot for each pair of blades.

Moving the blades in this manner is part of the method we disclose for optimizing the slot effect for a propeller having staggered pairs of blades, and especially at the outer third portion of the blades. The method involves an iterative process of CFD analysis and empirical testing to determine the optimal alignment of the forward and aft blades of a pair for a particular fluid medium, such as water and air, and for a particular application, such as for a particular boat hull size, shape and displacement at a target operating range. The same process is used for the other parameters of a pair of blades, including but not limited to, the amount of stagger, rake, skew, foil shapes, curvature, cupping, absolute and relative pitch, and blade area of the forward and aft blades. The methods are improved through the application of artificial intelligence by training propeller design and CFD testing systems on a growing dataset involving pairs of staggered blades, together with empirical testing to validate the computational and AI models.

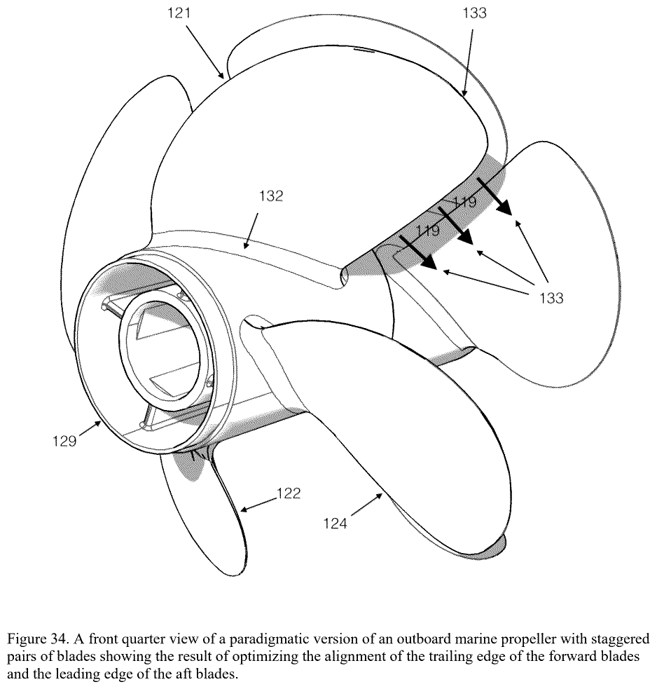

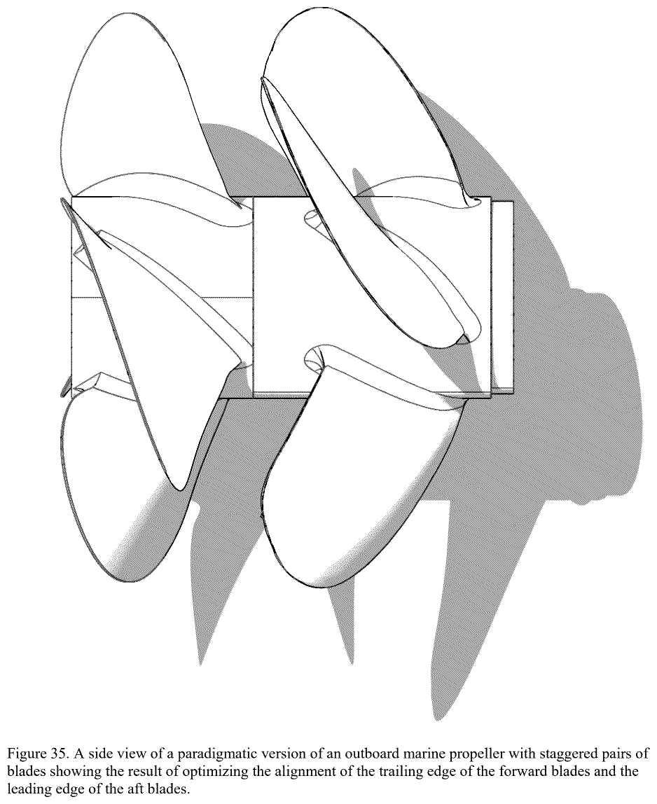

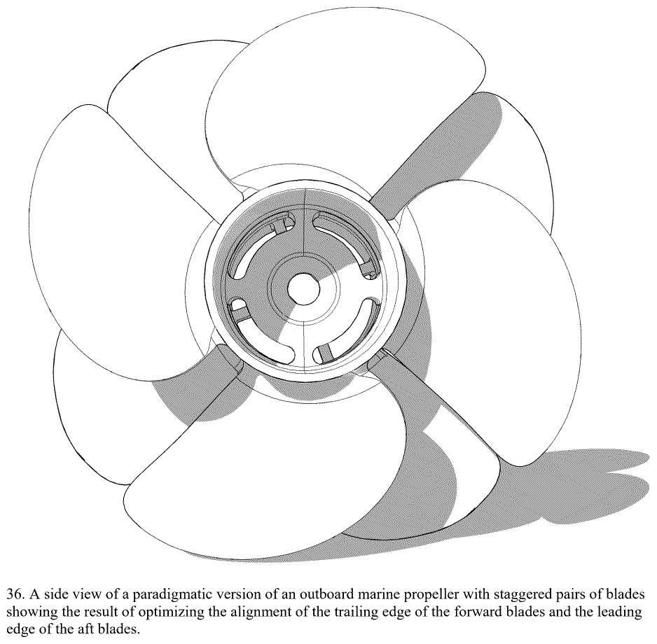

The result of employing the disclosed methods for optimizing the design of a propeller having staggered pairs of blades is shown in the series of FIGS. 33, 34 and 35. FIG. 33 shows a front view of a design better optimized for effective slot effect. FIG. 34 shows a side view of the same propeller design. FIG. 35 shows a front quarter view. Thick arrows in FIG. 35 marked as 133 depict areas where the fluid medium moves through the slot, marked as 119, between a forward and aft pair of blades. In this series of paradigmatic representations of the present invention, the slot is effective for reducing turbulence across the blade faces at the outer third of the portion of the blades when the distance between the trailing edge of the forward blade and the leading edge of the aft blade of a pair of staggered blades. The slot is more effective for reducing turbulence and promoting laminar flow through the slot and around the blades when the forward and aft blades are properly aligned for this effect. In this paradigmatic version of the present invention for marine outboard propellers, which applies well to other types of propellers as well, the slot will be more effective when the distance between the trailing edge of the forward blade and the leading edge of the aft blade of a pair of staggered blades at the outer third section of the blade pair is, on average, a ratio of less than 2 times the distance between the two edges at the middle section of the propeller, and the same ratio often holds when comparing the outer third section of the blades to the inner third section. In the paradigmatic version shown in these figures, the ratio of the distance between the two blades at the inner, middle and outer third sections is very close, varying as a ratio in a comparison between any two of the sections by less than 1.3 times the distance between the trailing edge of the forward blade and the leading edge of the aft blade of a pair of staggered blades. In FIG. 36, a side view of a paradigmatic version of an outboard marine propeller with staggered pairs of blades and an optimized alignment of forward and aft pairs of blades is shown.

The same methods are used in an iterative approach employing CFD analysis, empirical testing, and training of AI systems for analyzing the data from these analyses and predicting the results of different types of configurations to determine the other relevant parameters of staggered pairs of blades. The key parameters determined by these methods include, but are not limited to, the rake, skew, pitch, foil shape, curvature, slot size and shape, blade area, blade lengths, chord length, and blade thickness of the forward blade as compared to the aft blade.

The diagrams above are not intended to convey distinctions between solid vs. hollow blades, or variations in internal material composition and structural density, unless explicitly noted. Instead, the focus of the flat analytical sections is to clarify hydroynamic or aerodynamic and geometric variation across the blade span, emphasizing how these features contribute to slot formation and cooperative airflow (or waterflow) between blade pairs.

### KEY TO ILLUSTRATIONS

111. Cross section view of a forward blade of a staggered pair of blades.
112. Midsection line of the forward blade of a staggered pair of blades.
113. Extension of the straight chord line of the forward blade of a staggered pair of blades.
114. Aft blade of a staggered pair of blades pair of blades.
115. Midsection line of the aft blade of a staggered pair of blades.
116. Extension of the straight chord line of the aft blade of a staggered pair of blades.
117. Angle created by intersection of the straight chord lines of a staggered pair of blades reflecting, in this illustration, a relatively greater pitch angle of the aft blade in comparison to the forward blade.
118. Forward end of the cross section of a staggered pair of blades.
119. The general area of the slot between the forward and aft blades of a staggered pair, which is here defined by the area between the extension of the chord lines between the two blades of the pair.
120. Direction of the rotation of movement of the pair of blades relative to the fluid medium passing around the propeller.
121. Leading edge of the forward blade of the staggered pair.
122. Trailing edge of the forward blade of the staggered pair.
123. Leading edge of the aft blade of the staggered pair.
124. Trailing edge of the aft blade of the staggered pair.
125. Aft end of the cross section of a staggered pair of blades.
126. Forward blade of a staggered pair of blades.
127. Aft blade of a staggered pair of blades.
128. Separation distance between trailing edge of the forward blade of the staggered pair leading edge of the aft blade at the outer ⅓ portion of the staggered pair approximately at a position approximately ¾ of the distance between the root and the outer tip of the two blades.
129. Forward portion of hub of an attachably detachable two-part forward propeller of a pair.
130. Aft portion of hub of an attachably detachable two-part hub of forward propeller.
131. Portion of propeller shaft entering the forward portion of the hub.
132. Blade base where it attaches to the hub at its root.
133. Outer tip of blade.
134. Thick arrows depict an area where a fluid medium moves through the slot between a forward and aft pair of blades.

### DESCRIPTION OF PRIOR ART AND PLATFORM FOR INNOVATION

Teignbridge Propellers has developed an advanced marine propulsion system featuring a propeller with a circular outer ring joined to the tip ends of the blades. This configuration enhances structural integrity and contributes to improved flow dynamics around the blade tips, reducing cavitation and tip vortex losses. Each blade in the Teignbridge design includes an adjustable trailing edge tab, functionally akin to a trim tab on a rudder. These adjustable tabs enable real-time or pre-set modifications of the blade pitch, allowing the propeller's effective thrust characteristics to be fine-tuned for different operational conditions. This is particularly valuable for vessels that require frequent changes in thrust direction or intensity, such as tugboats and ferries operating in constrained harbors or docking scenarios.

The propeller is integrated into a rotating propulsion unit driven by an electric motor. This assembly is engineered to deliver omnidirectional thrust capabilities, with the entire unit rotating to vector thrust in multiple directions relative to the hull of the vessel. The combination of electric drive, pitch-adjustable tabs, and a tip-ring-enhanced propeller results in a compact, efficient, and highly maneuverable propulsion solution well suited to specialized marine applications.

Building upon this platform, the present invention introduces a novel variation of this propulsion system in which the propeller comprises pairs of staggered blades, each pair including a forward blade and an aft blade. The staggered configuration is engineered to optimize the slot effect between the blades, improving thrust efficiency and promoting smoother laminar flow between the pressure face of the forward blade and the suction face of the aft blade.

In a paradigmatic embodiment of the invention, both the forward and the aft blades in each pair are equipped with adjustable pitch tabs on their trailing edges. These tabs can be independently or jointly adjusted to fine-tune the relative pitch and flow alignment between the forward and aft blades, further enhancing the slot effect under varying load and flow conditions.

In alternative embodiments, only the forward blade or only the aft blade of each pair includes the adjustable pitch tab. These configurations provide flexibility in design and manufacturing while still offering enhanced control over thrust generation and hydrodynamic efficiency. When combined with the outer ring and rotating drive unit, these propellers provide a highly adaptable solution capable of being tuned for a wide range of vessel types and operational scenarios.

The outer ring of this marine application directly applies to the design of turbofan propellers with staggered blades. A paradigmatic version of the present invention is a turbofan propeller having one or two outer rings connecting the outer tips of the fan blades. A variation of this configuration comprises one or two rings located at a midpoint of the fore and aft fan blades to separate the inner portion of the blades that drive air into the turbine from the outer portion of the blades that bypass the turbine and provide a significant portion of the thrust of the jet engine.

Prior Art References

| | | Assignee/ | |
|---|---|---|---|
| Patent/Publication | Title | Inventor | Summary & Relevance |
| U.S. Pat. No. | Compound | George E. Bliss | Describes a compound propeller blade |
| 2514487A | Propeller Blade | | with an adjustable configuration for |
| | | | improved aerodynamic efficiency. |
| | | | Relevant for early concepts of blade |
| | | | geometry optimization. |
| U.S. Pat. No. | Dual Air Screw | Francis A. | Details a propeller system with two |
| 3282352A | Propeller | Chapin | air screws arranged for counter- |
| | | | rotation or cooperative airflow |
| | | | generation. Pertinent to dual-blade |
| | | | configurations. |
| U.S. Pat. No. | Hydropropeller | Albert W. Foster | Introduces a marine propeller with |
| 3514215A | | | hydrodynamically optimized blades. |
| | | | Offers insights into blade design for |
| | | | fluid dynamics. |
| US20040062654A1 | Axial Flow Fan | Denso | Describes an axial fan with staggered |
| | with Multiple | Corporation | blades arranged in reverse order for |
| | Segment Blades | | cooling systems. Relevant for |
| | | | staggered blade configurations in fans. |
| U.S. Pat. No. | Turbo-Machine | William J. | Presents a turbomachine with airfoil |
| 3075743A | with Slotted Blades | Rollins | blades containing slots intended to |
| | | | manage fluid dynamics. Discusses slot |
| | | | effects in blade design. |
| US20240352942A1 | Tandem Blade | Raytheon | Discloses a rotor disk configuration |
| | Rotor Disk | Technologies | for turbine engines using tandem |
| | | Corporation | blade pairs spaced and oriented to |
| | | | improve performance. Directly related |
| | | | to staggered blade pairs. |
| U.S. Pat. No. | Group of Blade | Rolls-Royce | Details optimized arrangements of |
| 10584604B2 | Rows | PLC | blade rows for gas turbine engines, |
| | | | potentially including tandem or |
| | | | staggered configurations. Pertinent to |
| | | | blade row grouping strategies. |
| U.S. Pat. No. | Tandem Blade | John C. | Describes a rotor disk assembly with |
| 11549518B2 | Rotor Disk | DiTomasso, | tandem blade sets designed to enhance |
| | | Raytheon | turbine performance through |
| | | Technologies | optimized spacing and interaction. |
| | | Corporation | Highly relevant to your design. |
| US20160108735A1 | Tandem Rotor | Raytheon | Explores tandem blade arrangements |
| | Blades | Technologies | in gas turbine engines to improve |
| | | Corporation | airflow and efficiency. Supports |
| | | | concepts of blade pairing. |
| EP3290637B1 | Tandem Rotor | Raytheon | Enhances the tandem rotor blade |
| | Blades with | Technologies | concept with cooling pathways and |
| | Cooling Features | Corporation | thermodynamic performance |
| | | | improvements. Relevant for thermal |
| | | | management in blade design. |
| US20160369816A1 | Tandem Rotor | Raytheon | Corresponds to EP3290637B1; |
| | Blades with | Technologies | however, this US application was |
| | Cooling Features | Corporation | abandoned. Discusses tandem blades |
| | | | designed for improved heat |
| | | | management in turbines. |
| U.S. Pat. No. | Staggered | George E. Bliss | Describes a propeller with axially |
| 2432391A | Propeller | | spaced blades mounted on posts, |
| | | | allowing for staggered blade |
| | | | configurations to optimize airflow. |
| | | | Early reference to staggered blade |
| | | | arrangements. |
| US20210141947A1 | Propeller Design | [Assignee not | Outlines a computer-implemented |
| | Systems and | specified] | method for designing and optimizing |
| | Methods | | propeller blades using |
| | | | multidisciplinary optimization |
| | | | techniques, including CFD |
| | | | simulations and performance analysis |
| | | | routines. Relevant for computational |
| | | | design methods. |
| US20210253236A1 | Rotary Airfoil and | [Assignee not | Details a design method enabling |
| | Design Method | specified] | computational prediction of airfoil |
| | | | performance via CFD, facilitating |
| | | | iterative optimization of airfoil |
| | | | shapes. Pertinent to computational |
| | | | optimization. |
| CN102530212A | Self-Adaptiv/e | [Assignee not | Introduces a propeller blade design |
| | Biomimetic | specified] | inspired by biological structures, |
| | Composite | | featuring adaptive flexibility to |
| | Propeller Blade | | optimize performance in varying flow |
| | | | conditions. Relevant for biomimetic |
| | | | design approaches. |
| U.S. Pat. No. | Ring-Shrouded | [Assignee not | Describes a propeller with a |
| 5096382A | Propeller | specified] | continuous ring-shroud attached to |
| | | | blade tips, enhancing structural |
| | | | integrity and aerodynamic |
| | | | performance. Pertinent to ring |
| | | | structures in propeller design. |
| U.S. Pat. No. | Propulsive Thrust | [Assignee not | Details a low-aspect ratio propeller |
| 5470202A | Ring System | specified] | system with multiple ring structures to |
| | | | augment and control thrust in various |
| | | | applications. Supports concepts of |
| | | | ring-enhanced propulsion. |
| U.S. Pat. No. | Propeller | [Assignee not | Features a propeller assembly with |
| 5180286A | Assembly | specified] | replaceable blade assemblies secured |
| | | | within slots, allowing for modularity |
| | | | and ease of maintenance. Relevant for |
| | | | modular and adjustable propeller |
| | | | designs. |

Additional References

| Publication | Title | Authors | Summary & Relevance |
|---|---|---|---|
| arXiv:0803.3738 | Searching Optimal | Gianluca | Discusses a nonlinear differential |
| | Shapes for Blades of a | Argentini | equation about optimal shapes for |
| | Fan | | blades of a fan, providing a |
| | | | mathematical foundation for blade |
| | | | shape optimization. |
| arXiv:2309.13195 | Enhancing Axial Flow | Johannes P. | Explores the use of blade tip |
| | Fan Performance in Air- | Pretorius, | modifications to control blade tip |
| | Cooled Condensers | Sybrand J. Van | leakage flow, enhancing fan |
| | | der Spuy | efficiency. Relevant for tip design |
| | | | considerations. |
| arXiv:1208.6396 | Design and Experimental | Hussain Nouri | Presents an experimental study on |
| | Validation of a Ducted | et al. | the design of counter-rotating axial- |
| | Counter-rotating Axial- | | flow fans, offering insights into |
| | flow Fans System | | ducted fan configurations. |
| arXiv:1910.09030 | Supporting Multi-point | Pranay | Investigates dimension reduction in |
| | Fan Design with | Seshadri et al. | turbomachinery 3D CFD |
| | Dimension Reduction | | simulations, aiding in efficient |
| | | | design space exploration. |

1. A radial propeller for generating thrust in a fluid medium, comprising:
a. a central hub configured for attachment to a rotating drive shaft and having an axial center of rotation with a forward end and an aft end;
b. a plurality of propulsion blades arranged radially around the central hub;
c. wherein each blade has a base end attached to the hub, a tip end, a leading edge, a trailing edge, a front side, and a back side;
d. a plurality of propulsion blades arranged in axial spaced pairs, each pair comprising a forward blade and an aft blade;
e. wherein, in each pair, the trailing edge of the forward blade is aligned with the leading edge of the aft blade,
f. wherein, in each pair, chord lines of the forward and aft blades are configured in a diagonal offset relative to one another, defining an effective slot there between,
g. wherein the slot between the forward blade and the aft blade of each pair is adapted to permit the passage of a fluid medium between the front side of the forward blade and the back side of the aft blade, and around opposite sides of each blade, during rotation in the fluid medium.

2. The propeller of claim 1, wherein the diagonal offset of the forward and aft blades of a pair at the outer third portion has an average distance less than 2× the average distance of the diagonal offset of the forward and aft blades of the middle third section.

3. The propeller of claim 1, wherein the length from base to tip of a plurality of the blades exceeds the diameter of the hub.

4. The propeller of claim 1, wherein the cross-sectional profile of each blade comprises a complementary foil shapes configured to produce lift-like forces during rotation, wherein the foil shapes of the forward and aft blades are adapted for efficient passage of a fluid medium between the front side of the forward blade and the back side of the aft blade during rotation in the fluid medium.

5. The propeller of claim 1, wherein the trailing edge of the forward blade is aligned with the leading edge of the aft blade at the outer third sections of the pair of blades, wherein the alignment of the blades is adapted for laminar flow of a fluid medium between the front side of the forward blade and the back side of the aft blade through the slot during rotation of the propeller in the fluid medium.

6. The propeller of claim 1, further comprising a circular ring attached to the tip ends of a plurality of blades, wherein the ring is configured to rotate with the blades.

7. The propeller of claim 1, wherein the propeller is configured to rotate within a fixed duct surrounding the outer perimeter of the blades.

8. The propeller of claim 5, wherein the circular ring is configured to rotate within a fixed duct that surrounds the outer perimeter of the ring.

9. The propeller of claim 1, wherein a plurality of the blade pairs are attachably detachable from the central hub.

10. The propeller of claim 1, wherein the central hub comprises at least a forward section and an aft section that are attachably detachable from one another, and wherein the forward blades of a plurality of pairs attach to the forward section of the hub, and the aft blades a plurality of pairs attach to the aft section of the hub.

11. The propeller of claim 10, wherein the relative radial or axial position of the forward and aft sections of the hub is adjustable to alter the position and alignment of the blades.

12. The propeller of claim 1, wherein the blades are configured as feathering blades.

13. The propeller of claim 1, wherein the pitch of the blades is adjustable.

14. The propeller of claim 1, wherein each blade comprises attachably detachable strips of material for adjusting the thickness of leading or trailing edge portions.

15. The propeller of claim 1, wherein each blade includes movable sections at or near the trailing edge.

16. The propeller of claim 1, wherein one or more blades include surface textures based on biomimetic patterns resembling fish scales or similar structures, wherein the patterns of textures are adapted for efficient flow of fluid through the slot between the front face of the forward blade and the back face of the aft blade of a pair of blades.

17. The propeller of claim 1, wherein the blade surfaces comprise a plurality of longitudinal microchannels or raised ridges with cross-sectional dimensions between 10 micrometers and 5 millimeters, said structures being adapted to suppress boundary layer turbulence.
The propeller of claim 1, wherein one or more blades comprise malleable portions made of composite materials including carbon fiber, aramid fiber, or functionally similar materials.

18. A radial propeller for use in a fluid medium,
a. comprising a central hub element adapted for attachment to a rotary shaft,
b. further comprising a plurality of elongate propulsion blade elements,
c. wherein the hub element has a forward end and an aft end along a rotation axis,
d. wherein a plurality of blades each have a base end connected to the hub and a tip end distal from the hub,
e. wherein the length from base to tip of a plurality of the blades exceeds the diameter of the hub,
f. wherein a plurality of the propulsion blades are arranged in pairs around the central hub,
g. wherein each pair comprising a staggered set have a forward blade and an aft blade relative to forward and aft ends of the hub,
h. wherein the chord lines of the forward and aft blade of a pair are offset along the rotation axis to define a slot between them,
i. wherein said slot is adapted to for passage of the fluid medium between the back surface of the forward blade and the front surface of the aft blade during rotation,
j. wherein the blades of each pair are aligned so that the distance between the chord lines of the fore and aft blades
k. wherein the blades have a foil cross-sectional shape adapted to generate lift in a gaseous fluid medium,
l. and wherein the arrangement of said staggered blade pairs is adapted to enhance thrust efficiency or flow induction by promoting laminar flow through said slots and around the blades.

19. The propeller of claim 18, wherein the slot between each forward and aft blade in a pair has a width at the outer third portion of the blade pair that is narrower than the maximum width of the aft blade, and wherein the slot geometry is configured to induce accelerated airflow and reduce wake turbulence.

20. The propeller of claim 18, further comprising a circular ring structure connecting the tip ends of the forward and aft blades of each pair, wherein said ring is configured to rotate with the propeller and adapted to prevent tip vortex losses.

21. The propeller of claim 18, wherein the blades are configured to rotate within a fixed duct surrounding the outer perimeter of the propeller, and wherein said duct is adapted to enhance laminar flow and thrust efficiency.

22. The propeller of claim 18, wherein the blades of each pair are shaped with a foil cross-section having a curved leading surface and a tapered trailing edge, and wherein said airfoil profile is adapted to maximize lift in a gaseous fluid.

23. The propeller of claim 18, wherein one or both surfaces of the forward and aft blades comprise microtextured patterns inspired by the dermal denticles of sharks or the scale geometry of fast-swimming fish, wherein said textures are adapted to promote laminar airflow over the blade surfaces.

24. The propeller of claim 18, wherein the blades are modularly mounted to the hub and are detachably secured, allowing substitution or adjustment of the forward and aft blades of each pair for different operating conditions.

25. The propeller of claim 24, wherein the hub comprises an adjustable forward section and an aft section, and wherein the relative radial or axial position of the two sections can be varied to alter the slot geometry between blade pairs.

26. The propeller of claim 18, wherein the pitch of one or more blades is adjustable, either manually or via an automated mechanism, to optimize thrust for changing airspeed or load conditions.

27. The propeller of claim 18, wherein the propeller is adapted for use on an aerial drone, and wherein the slot geometry and blade shape are optimized for low-noise, high-efficiency hovering and forward flight.

28. The propeller of claim 18, wherein the propeller is adapted for use in a wind turbine, and wherein the staggered blade arrangement is configured to maximize rotational torque in variable wind conditions.

29. The propeller of claim 18, wherein the propeller is adapted for use as a cooling fan, and wherein the slot geometry is configured to maximize flow rate while reducing noise generated by turbulence.
The propeller of claim 18, wherein the blade surfaces include flow-directing ridges or grooves adapted to channel airflow along the length of the slot to reduce pressure drag and flow separation.
The propeller of claim 18, wherein the aft blade of each pair is slightly twisted relative to the forward blade in the axial direction, the staggered configuration promotes continuous pressure gradients along the airflow path between the pair.

30. A method for designing and producing a propeller comprising forward-aft staggered blade pairs, the method comprising:
a. selecting an intended fluid environment and use case from among a set including marine propulsion, aerial propulsion, wind power generation, and electronic cooling;
b. identifying a plurality of design parameters relevant to the selected use case, said parameters including but not limited to: number of blade pairs, stagger angle, axial and circumferential slot spacing, airfoil profile, pitch, chord length, radial span, and surface texture;
c. conducting iterative fluid dynamics simulations using a computational fluid dynamics (CFD) engine to evaluate blade-pair performance across a set of parameter values;
d. validating CFD results by fabricating one or more test propellers and performing empirical performance testing;
e. using a computational search algorithm trained on simulation and test results to identify optimal or near-optimal parameter configurations for the intended use;
f. and, producing the propeller using materials and manufacturing methods suited to the selected use case.

31. The method of claim 30, wherein step (a) further comprises distinguishing between open-flow and ducted environments, and adjusting design targets accordingly.
The method of claim 30, wherein the fluid dynamics simulations of step (c) are configured to resolve slot flow behavior and detect laminar separation, micro-vortices, and pressure recovery across blade faces.

32. The method of claim 30, wherein the computational search algorithm of step (e) comprises a genetic algorithm, Bayesian optimization, or reinforcement learning system trained to maximize thrust-to-power ratio and reduce flow separation.

33. The method of claim 30, wherein the empirical testing of step (d) comprises measuring thrust, efficiency, torque, and acoustic emissions at multiple rotation speeds.

34. The method of claim 30, wherein the method is used to design propellers for cooling systems in electronic devices, and the parameter optimization prioritizes low noise and high airflow at low power draw.

35. The method of claim 30, wherein the method is used to design aerial propellers for drones, wherein optimization includes tradeoffs between hovering efficiency, forward-flight thrust, and battery usage.
The method of claim 30, wherein the method is used to design marine propellers for vessels operating at both displacement and planing speeds, and the optimization includes consideration of cavitation thresholds and water entrainment.

36. The method of claim 30, wherein step (e) further comprises generating a design space map using dimensionality reduction techniques such as principal component analysis (PCA) to visualize and select promising configurations.

37. The method of claim 30, wherein the CFD analysis of step (c) includes comparison of staggered blade performance against non-staggered single-blade configurations for the same radial footprint.

38. The method of claim 30, wherein the final production of step (f) comprises additive manufacturing, precision casting, or automated composite layup techniques depending on the selected environment and scale.
